(19) United States
(12) Patent Application Publication
(10) Pub. No.: US 2001/0002552 A1
(43) Pub. Date: Jun. 7, 2001

(54) DIGITAL REMOTE GAUGE ASSEMBLY

(76) Inventor: PETER VINCI, KIRKWOOD, PA (US)

Correspondence Address: WITOLD A ZIARNO, MICHAEL BEST & FRIEDDRICH, 100 EAST WISCONSIN AVENUE, MILWAUKEE, WI, 532024108

(21) Appl. No.: 09/228,571

(22) Filed: Jan. 11, 1999

Related U.S. Application Data
(60) Provisional application No. 60/017,138, filed on May 17, 1996.

(51) Int. Cl. G01L 9/00

(52) U.S. Cl. 73/753

(57) ABSTRACT

The present invention includes a portable, damage resistant, palm-held, low cost, high sensitivity ergonomically dimensioned digital remote gauge assembly unit for the measurement of external parameters that include by way of example temperature, pressure, and vacuum; a kit having a digital remote gauge assembly unit, a variety of probes and adapters that provide for the communication signals to the unit in response to externally measured parameters, and a communication link between a respective probe and the digital remote gauge assembly unit; and, a method of utilizing the kit and device to facilitate the rapid measurement of a variety of external parameters. The digital pressure gauge includes a gauge body dimensioned to be held in the palm of a user's hand. The gauge body has microprocessor controlled circuitry therein, an altitude and temperature compensated pressure transducer in communication with the microprocessor, and keys for actuating the microprocessor. The body also includes a display for informing the user of readings taken in a mode of operation of the device, a probe assembly; and, a multi-conductor shielded cable connecting said gauge body and said probe assembly. The gauge also includes routines providing a plurality of said modes of operation of the gauge including a PSI mode, a KPA mode, a PEAK HOLD mode, a HI/LO resolution mode, and a temperature mode in which said display presents a temperature of a fluid being tested in either °C. (Centigrade) or °F. (Fahrenheit).

### CONTINUING DATA

This application is a continuation in part patent application of U.S. provisional patent application Ser. No. 60/017,138 entitled “Digital Remote Gauge Assembly,” filed on May 17, 1996 by Peter Vinci.

### BACKGROUND OF THE INVENTION

This invention generally relates to remote sensing gauges, and gauge assembly systems; and, more particularly, it relates to a digital remote gauge assembly, a kit used in the remote sensing of external parameters, and method of utilization thereof.

Various instruments are known including those described in U.S. Pat. Nos. 4,696,189, 5,377,128, 5,375,073, 5,365,462, 5,089,979, and 5,347,476. Traditional remote gauge assembly systems have problems associated with the manufacture and usage thereof that include, by way of example, high cost, bulkiness, and a lack of portability and maneuverability. It is an object of the present invention to solve these and other problems in the art.

### SUMMARY OF THE INVENTION

The present invention provides an ergonomic, lightweight, portable, readily maneuverable, self-powered, palm-held, digital remote gauge assembly unit; a kit having a digital remote gauge assembly unit, a variety of probes that communicate signals to the unit in response to externally measured parameters, and a communication link between a respective probe and the digital remote gauge assembly unit; and, a method of utilizing the kit and device to facilitate the rapid measurement of a variety of external parameters including by way of example, temperature, pressure, and vacuum. The digital gauge assembly provides an untrained or unskilled user with a rapid means for measuring and rapidly quantifying a plurality of different parameters without need for extensive training in the use of the device.

It is yet another object of the invention to provide a digital pressure gauge that includes a gauge body dimensioned to be held in the palm of a user's hand. The gauge body has microprocessor controlled circuitry therein, an altitude and temperature compensated pressure transducer in communication with the microprocessor, and keys for actuating the microprocessor. A display is disposed on the gauge body for informing the user of readings taken in a mode of operation of the device. The gauge body also includes a probe assembly; and, a multi-conductor shielded cable connecting the gauge body and the probe assembly. The cable provides a communication link between the probe assembly and the circuitry, and is dimensioned and constructed to allow a user to manipulate the keys on the gauge body while the probe assembly is in an actual test position on a component of a vehicle, while the vehicle is in motion and while the user is operating the vehicle.

It is yet a further object of the invention to provide a digital pressure gauge of having a plurality of the modes of operation of the gauge. The modes of operation of the gauge include a PSI mode in which the display presents a pressure read in pounds per square inch measurement, a KPA mode in which the display presents a pressure reading in kilo pascal, a PEAK HOLD mode in which the display presents a highest pressure read during a sample of measurements taken by the gauge, a HI/LO resolution mode in which the display displays one of a LO resolution mode in which the display presents an average pressure taken from a batch of at least 8 consecutive readings or a HI resolution mode in which the display presents the pressure in a system being measured in real time, and a temperature mode in which the display presents a temperature of a fluid being tested in either °C. (Centigrade) or °F. (Fahrenheit).

The probe assembly houses the pressure transducer and a temperature compensation component, includes a JIC connector, and is constructed of a heat passive alloy.

The invention also provides a kit for remotely measuring pressure or temperature. The kit includes the digital remote pressure gauge described herein, and at least in the range of three or more digital remote pressure gauge accessories. The accessories are selected from the group consisting of lithium batteries (CR2032), a gauge boot, an adapter kit manual & look-up tables; adapters selected from the group consisting of an F1AS adapter, an F2AS adapter, an F3AS adapter, an F4AS adapter, an F5AS adapter, anF6 adapter, an F7AS adapter, an F8 adapter, an F9 adapter, an F10AS adapter, an F11 adapter, an F12 adapter, an F13AS adapter, an F14 adapter, an F15 adapter, an F16AS adapter, an F17AS adapter, an F18AS adapter, an F19AS adapter, an F20AS adapter, an F21AS adapter, an F22AS adapter, an F23 adapter, an F24AS adapter, an F25 adapter, an F26AS/2 adapter, screws (M6×1.0×50 mm), an F27 adapter, an F28 adapter, an F29 adapter, an F30AS adapter, an F31 adapter, an F32 adapter, a 45°elbow, a 90° elbow, hose clamps, a ⅜″ ID Hose/3″ length, a ¼″ ID Hose/3″ length, ¼″ ID fuel flex tubing, a w/male 7/16 JIC/4″ length, a manifold assembly, a manifold extension hose, an accessory gag, 5″ Zip strips, 8″ Zip strips, a knee-board attachment, an air chuck, a bottle, and a blow-molded case.

It is yet a further object of the invention to provide a method of measuring a pressure or temperature on a component of a vehicle while the vehicle is moving and in operation. The method includes the steps of providing a digital pressure gauge, the digital pressure gauge having a gauge body dimensioned to be held in the palm of a user's hand, the gauge body having microprocessor controlled circuitry therein, an altitude and temperature compensated pressure transducer in communication with the microprocessor, and keys for actuating the microprocessor; a display disposed on the gauge body for informing the user of readings taken in a mode of operation of the device; a probe assembly; and, a multi-conductor shielded cable connecting the gauge body and the probe assembly, the cable providing a communication link between the probe assembly and the circuitry, and the cable of a length sufficient to allow a user to manipulate the keys on the gauge body while the probe assembly is in an actual test position on a component of a vehicle and while the vehicle is actually in motion and while the user is operating the vehicle; connecting the probe assembly to the component of the vehicle while the vehicle is stationary, the component being remote from a passenger compartment of the vehicle; positioning the gauge body in a convenient, easily viewable position with respect to the user in the passenger compartment of the vehicle; actuating movement of the vechicle; and, viewing readings on the display in response to actuating the keys on the gauge while the vehicle is moving.

The objects and features of the present invention, other than those specifically set forth above, will become apparent in the detailed description of the invention set forth below.

### BRIEF DESCRIPTION OF THE DRAWINGS

FIG. 1 illustrates a perspective view of the digital remote gauge assembly unit of the present invention;

FIG. 2 illustrates a top plan view of the digital remote gauge assembly unit of FIG. 1 and a perspective view of a communication link between a probe and the unit;

FIG. 3 illustrates a top plan view of the rear of the digital remote gauge assembly unit of FIGS. 1 and 2;

FIG. 4 illustrates an electrical schematic of the digital remote gauge assembly unit of FIG. 1;

FIG. 5 illustrates a front perspective view of the digital remote gauge assembly of the present invention having a sleeve and optional boot;

FIG. 6 illustrates a rear perspective view of the gauge assembly of FIG. 5;

FIG. 7 illustrates a close-up view of the gauge assembly of FIG. 6 without the boot;

FIG. 8 illustrates an initial screen of the gauge assembly of FIG. 5;

FIG. 9 illustrates a close-up view of the buttons used for calibration of the gauge assembly of FIG. 5;

FIG. 10 illustrates a calibration screen of the gauge assembly of FIG. 5;

FIG. 11 illustrates a zero reading screen of the gauge assembly of FIG. 5;

FIG. 12 illustrates pressure and temperature mode access screens of the gauge assembly of FIG. 5;

FIG. 13 illustrates a close-up view of the buttons used to access the screens of FIG. 12 of the gauge assembly of FIG. 5;

FIG. 14 illustrates pressure mode screens of the gauge assembly of FIG. 5;

FIG. 15 illustrates a close-up view of the buttons used to access the screens of FIG. 14 of the gauge assembly of FIG. 5;

FIG. 16 illustrates a PEAK HOLD screen of the gauge assembly of FIG. 5;

FIG. 17 illustrates a close-up view of the buttons used to access the screens of FIG. 16 of the gauge assembly of FIG. 5;

FIG. 18 illustrates a HI/LO RES Mode screen of the gauge assembly of FIG. 5;

FIGS. 19-21 illustrate various adapters, manifolds and accessories of the present invention;

FIG. 22 illustrates installation of a manifold of the present invention;

FIG. 23 illustrates fuel flow through a manifold of the present invention;

FIG. 24 illustrates a close-up view of the manifold connection of FIG. 23;

FIG. 25 illustrates attachment of the digital remote fuel pressure gauge to the manifold of FIGS. 22-24 of the present invention;

FIG. 26 illustrates a variant of the gauge of FIG. 5;

FIG. 27 illustrates a kneeboard of the present invention;

FIG. 28 illustrates a variant of the kneeboard of FIG. 27;

FIG. 29 illustrates a variant of the circuitry of FIG. 4; and, FIGS. 30-30b illustrate top, side, and frontal views of the battery clip of the present invention used in the gauge of the present invention.

### DETAILED DESCRIPTION OF THE INVENTION

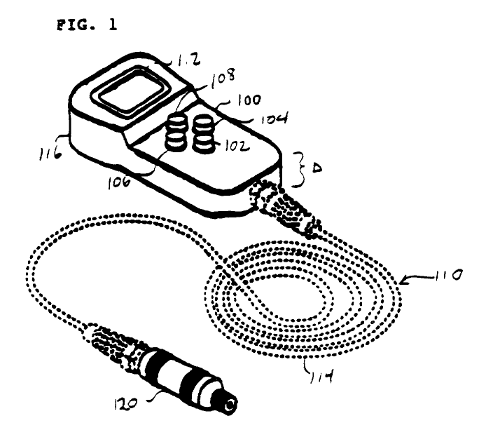

FIGS. 1-3 illustrate a perspective view, top plan and bottom plan view of digital remote gauge assembly unit 100. The theory of operation of digital remote gauge assembly unit 100 is as follows:

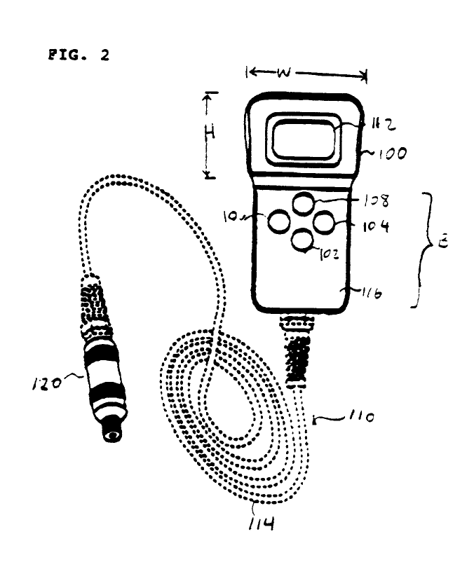

Gauge 100 includes ON/OFF button 102 (FIGS. 1 and 2). Button 102 is used to power up (turn unit 100 ON) and power down (turn unit 100 OFF). If unit 100 is in the off mode, pressing button 102 will turn it on. If unit 100 is in the on mode pressing button 102 will turn it off. Unit 100 must be powered up or ON for the function of any of the other buttons 104, 106, 108 to work. The only exception is back light (FIG. 4) which is designed to light the LCD (FIG. 4), irrespective of the mode unit 100 is in at any given time.

PEAK HOLD button 104 enables or disables the Peak Hold function or mode of unit 100. This feature allows a user to display the highest pressure reading on the LCD 112 of all the samples taken, and functions by comparing a new pressure reading with a old highest pressure reading still on the LCD 112. If the new reading is greater than the old highest pressure reading on the LCD 112 then the new value is placed on the LCD 112. This process repeats itself with every sample taken and an audible ‘BEEP’ or other signal can be heard every time the value changes on the LCD 112. The user presses button 104 again to turn this feature off and unit 100 then returns to updating the LCD 112 with every new sample taken.

AVERAGING/MODE button 106 enables and disables the Averaging or Temperature function or mode of unit 100. In the Averaging Mode, a number of pressure samples are taken and the average value of those samples is displayed on the LCD 112. During this time, while the new pressure samples are being taken, the previous result is displayed on the LCD 112. An audible ‘BEEP’ emanating from unit 100 can be heard every time the LCD 112 is updated.

Temperature can also be measured using the same probe assembly 110 (FIGS. 1-3). Temperature will be displayed either in degrees Centigrade or degrees Fahrenheit on display 112 (FIGS. 1-2). The user may choose the mode of operation of unit 100 by pressing the mode switch 106 multiple times and scrolling through the different features.

When unit 100 is in averaging mode a ‘+’ sign is displayed on the left hand side of the LCD 112. When in Centigrade a “degrees C.” is displayed on the LCD 112 and when in Fahrenheit a “degrees F.” is displayed on the LCD 112.

LIGHT button 108 button activates a backlight behind the LCD 112. The backlight remains on as long as the user is pressing button 108. This feature will work irrespective of the current mode of operation unit 100 is in.

A general description of operation of the unit and its method of operation is as follows: A user presses On/Off button 102 to power up the unit 100. To zero unit 100, a user holds down Peak Hold button 104 while turning unit 100 on. Unit 100 provides a self zeroing feature that eliminates all of the effects of altitude and temperature on unit 100. All readings from this point on will be calculated based on these readings. Although the temperature reading is recalibrated periodically, e.g. every minute of operation, to allow for any temperature changes at the pressure sensing die (FIG. 4).

Probe 120 having communication link 114 is then attached to a relevant port to measure the desired pressure. Communication link 114 includes a variety of communication links. Preferably communication link 114 is a communication link that provides strain relief. “Strain relief” communication links and portions thereof, include by way of example, components commercially available from Heyco Molded Products of Kenilworth, N.J. and coaxial-shielded cables available from C & M, Inc. of Wauregan, Conn. Right angle LED's used in the present invention are commercially available from Lumex. Inc. (model number ssf-lxh3051d-tr. In a normal mode, display 112 is updated periodically, e.g. approximately every second. Unit 100 also has a power saving feature that enables it to turn itself off automatically after five (5) minutes or other appropriate period of time. This feature is enabled when unit 100 fails to measure a pressure reading during any five minute or other appropriate time period.

The designation “S” generally includes a routine step utilized in the present invention. It is understood that various algorithms that will produce an analogous mode of operation are used in the present invention without departing from the invention's spirit and scope. Unit 100 features the following exemplary routine:

1—Power on—Set up all registers and counters—S100.

2—Display ‘888’ on LCD 112 with battery symbol—S200.

3—Take a pressure reading—S300.

4—Take a temperature reading—S400.

5—Take a battery reading—S500.

If the battery reading at S500 is low then display the battery symbol (not shown) on LCD 112—S600.

6—Check to see if Peak Hold button 104 in pressed—S700

If YES, zero all readings and store values—S800.

If NO, use current readings—S900.

7—Wait half second (or other appropriate period of time)—checking to see if Peak Hold button 104 and Averaging button 106 are being pushed—S1000.

8—Take a pressure reading S1100.

9—If Peak Hold button 104 pushed go to Peak Hold section S1200.

10—If Averaging selected go to Averaging section S1300.

11—If Temperature selected go to Temperature section S1400.

12—If nothing selected then calculate pressure using values obtained from pressure reading and temperature reading S1500.

13—Go to display routine and display pressure S1600.

14—Check pressure value S1700—If it is zero then start five minute counter S1800. If it is not zero then reset five minute counter S1900.

15—Go to 7 and repeat.

The Peak Hold section S1200 includes the following routine:

1—Calculate pressure using values obtained from pressure reading and temperature reading sensors PHS 100.

2—Compare old reading with new reading PHS 200.

3—If new reading is greater than old reading then store it for comparison of next new reading and display value PHS 300.

If new reading is less than old reading then display old reading PHS 400.

4—Go to 7 and repeat.

The Averaging section S1300 includes the following routine:

1—Add new pressure reading to previous pressure readings AS100.

2—Repeat step 1 for desired number of samples AS 200.

3—If desired number of samples has been taken, then divide the final number by the number of samples taken AS 300.

4—Calculate pressure using values obtained from the samples and temperature reading and display this value AS 400.

5—Go to 7 and repeat AS 500.

The Temperature section 1400 includes the following routine:

1—Take a temperature reading TS 100.

2—Calculate value TS 200.

3—Display value TS 300.

4—Go to 7 and repeat TS 400.

The operation of unit 100 includes a gauge usage mode. In the gauge usage mode a user presses On/Off button 102 to power up unit 100. Unit 100 immediately performs a self zeroing function to eliminate the effects of altitude and temperature. Probe 120 is then inserted into the relevant port for measuring the desired pressure.

Display 112 is updated periodically, e.g. approximately every second, for an appropriate or desired period of time, e.g. period of 10 minutes. This update speed can become confusing to the inexperienced user, with very quick fluctuations, therefore an averaging mode of operation has been included with unit 100. The averaging mode of operation limits the display update of unit 100 to update every 10 seconds for the 10 minute period, thus giving a reading which is more stable. Of course, other period updates at desired time periods are also used herein.

Probe 120 can include a variety of sensors and probes for measuring various characteristics of a system, e.g. pressure, temperature, etc. An optional probe 122 (not shown) is attached to unit 100 for measuring temperature. This feature is accessed using the MODE switch 106 of unit 100 to switch to the temperature reading system. Temperature will be displayed either in degrees Centigrade or degrees Farenheight on LCD 112. The user may choose this feature by pressing mode switch 106. Mode switch may optionally be a separate button from the buttons 104-108. The display screen 112 is updated periodically, e.g. every second for the 10 minute time period with the option of actuating the average mode.

A backlight feature of unit 100 facilitates viewing display 112 in the dark or low light environment, and is enabled for as long as light switch 108 is actuated.

Unit 100 includes a unique mode of gauge operation. The object of the design of unit 100 and the circuitry utilized herein (FIG. 4) is to provide 0.1% pressure resolution and +/−0.5% accuracy in a 100 psi full scale gauge at low cost. The key to the performance of this gauge is the use of a silicon pressure sensor (FIG. 4) that, while having a highly variable offset and sensitivity, is relatively linear. A microcomputer (FIG. 4) is used to zero the offset for each reading. The unit also includes a feature that applies a calibration to correct the sensor sensitivity and the tolerance of the other components such as the integrating capacitor, the op amp and the comparator (FIG. 4).

Pressure is sensed by a silicon bridge pressure transducer (FIG. 4). The sensor output is amplified by a factor of about 14 in a standard instrumentation amplifier configuration using three sections of IC2, an LM324 quad op amp. Resisters R1, R2 and R3 set the gain with R2 also setting enough offset to assure that even if the offset of the sensor is at the worst case end of the specification, there will be a positive signal to measure. This offset is set to about 66 mV to cover the specified 32 mV offset times the gain of the amplifier plus a margin. Power to the sensor and the amplifier is controlled by the microcomputer port pin RA5 to apply power only when a reading is being taken. Capacitor C4 is a local bypass for this power.

To achieve the desired resolution, at low cost, a simple integrating A/D is used. The A/D consists of Resistor R10 and film capacitor C1 feeding comparator IC3. The charging and discharging of the integrator is controlled by a microcomputer port pin RA3. Because the usable input range of the comparator and amplifier is from 0 to 2.5 Volts from the 4 Volt power supply, the integrator capacitor is first charged to the full supply voltage. The time for the capacitor to be discharged is measured by the microcomputer. Resistors R11 and R13 provide a small amount of hysteresis to keep the comparator from oscillating at the transition. The transition of the comparator is fed to the microcomputer port pin RC2 which is the capture timer input. The capture function in the microcomputer allows precise timing because the timer value is captured at the transition even if the microcomputer is otherwise occupied.

To provide temperature compensation of the pressure sensor, a thermistor is used along with resister R5 as divider (FIG. 4). The temperature sensor is powered by microcomputer port pin RA2 when a temperature reading is taken. To keep the pressure sensor output from affecting the temperature reading, the signal from the pressure sensor is eliminated by grounding it using microcomputer port pin RA4. Resistor R12 protects the output of the op amp and prevents excessive power supply drain.

Battery voltage is sensed through a high impedance resistor divider consisting of R6 and R7 to minimize the load on the battery to about 2 uA. This divider keeps the battery voltage within the input range of an op amp which is the fourth section of IC2. The battery voltage amplifier is coupled to the A/D input through resistors R8 and R16. When a voltage reading is to be taken, the power to the thermistor is turned off by making RA2 an input, the output of the pressure sensor is shorted with RA4, and RA0 is made an input to allow the battery signal to the A.D.

When the battery voltage is not being read, RA0 is made a low output to keep the output of the amplifier from influencing the other readings. Power is supplied from the batteries through a 4 Volt regulator which has very low quiescent current to minimize battery drain. Capacitors C2 and C3 keep the regulator stable. The sounder is driven directly from the microcomputer through port pin RC0. The microcomputer generates a 4 kHz square wave signal to drive the sounder.

The clock for the microcomputer is generated with a ceramic resonator CR along with capacitors C5 and C6 and circuits in the microcomputer to form an oscillator.

The microcomputer reset circuit consists of pull up resistor R15 and switch S1. At the end of each reading cycle, the microcomputer is put in sleep mode which is a very low power consumption mode. When the switch is closed and released, the microcomputer is reset and starts a new cycle.

Switches S2 through S5 provide extra functionality to the product. S2 provides a MODE function though which is accessed alternate features such as temperature reading options. S3 enables an Averaging mode in which the readings are sampled, averaged and the display updated approximately 10 times less frequently than in standard mode. S4 gives a Backlight function for the display. S5 is multiplexed to the sounder output and has yet to be defined.

The display is a two-level multiplexed LCD. The display segments are driven by microcomputer port pins RB0 to RB7 and RC5 to RC8. The two planes are driven by RC1 and RC3. To provide the intermediate voltage on the plane lines, resistors R17 to R20 form a pair of voltage dividers.

The timing of the drive signals from the plane and segment drivers is such as to provide a 4 volt AC wave form for segments that are off. This conforms to the requirements that there be AC signals only on each segment. The timing is critical so the display is turned off during A/D conversions so the AC waveforms are not interfered with by the reading processes.

Unit 100 features a test and calibration mode of operation. The test system is driven by a National Instruments PC-LPM-16 A/D and digital I/O cared in an IBM compatible personal computer. A series of tests and measurements are performed and calibration factors are calculated and then programmed into the EPROM in the microcomputer on the gauge. The test system consists of a program running on the PC written with National Instruments LabWindows for DOS and Microsoft Basic and a test program in the pressure gauge that interacts to provide a series of measurements to test the gauge performance and support the calculation of calibration factors.

A first test mode of operation is used to verify that the voltage regulator is functioning within limits. The microcomputer is taken out of reset with voltage applied to the op amp power port pin RA5. This invokes the test software in the microcomputer. The transition from one test to the next is caused by raising and lowering the voltage on the port pin RB6. The tests run include taking a zero pressure reading, a temperature reading, a battery voltage reading and a reading from applying a known voltage to the A/D with the other sources disabled. Then a standard pressure is applied and readings taken. For the zero pressure, reference voltage, and the test pressure, the digital value measured by the microcomputer is read out by clocking RBI and reading the 16 bit data on RBI on bit at a time.

The calibration table for the pressure readings consists of a piece-wise linear model of the exponential curve of the RCA integrating A/I. There are 55 table entries that are calculated from the test readings as well as calculated values of a calibration factor for sensitivity and low battery voltage as well as a fixed temperature compensation factor are set up in an array.

There is provision for four sets of calibration factors. A byte in the beginning of program memory (location 02H) is used to indicate which tables are available. A bit is programmed for each table used. The microcomputer is put into programming mode by raising the reset line to 12 Volts. The memory table byte is first read. This directs the PC program as to how many memory locations to index before starting the programming process. Each byte is verified after programming.

Each test is reported on the screen. Only if all of the tests are passed does the programming proceed. Any failure designation points to the section of the circuit as described above.

The pressure sensor wiring is particularly fragile. A failure of the pressure offset or pressure test will often be due to a broken wire or a solder short. This can be traced by looking at the two output lines. No voltage on either of them suggests that the supply line is open. Likewise, both high suggests that the ground line is open. If one line is at around 2 Volts and the other is high or low, there is an open or short on that line.

The circuitry and functionality of unit 100 facilitates for rapid, low cost, universal expansion of the capabilities of the unit 100. In that regard a variant of unit 100 provides for a 4 Digit display allowing pressures up to 4000 PSI by an RS232 communication link or other appropriate communication link to a host computer (not shown) from unit 100. Multiple units 100 are also contained in the same package. Unit 100 also includes circuitry and routines that allow for simultaneous temperature and pressure readings to be taken and displayed on unit 100. The present invention also utilizes interchangeable probes 120 having different sensing capabilities that are universally adaptable to communication link 114 for provision of signals to unit 100.

In the field, a user presses On/Off button 102 to power up or power down unit 100. A zeroing function is automatically activated to eliminate the effects of altitude and temperature. Optionally, the zeroing function is manually activated by the user on an as needed basis.

Probe 120, or other appropriate sensor, is inserted into the relevant port for measuring the desired pressure. The temperature is measured automatically, on a regular basis, so as to adjust for this variable. Display 112 is updated approximately every second for a period of 1 Hour. This update speed can become confusing to the inexperienced user, with very quick fluctuations, therefore an averaging mode has been included. The average mode limits the display to update at a much slower rate for the 1 Hour period, thus giving a reading which is more stable. An optional probe (not shown) may be attached to the unit for measuring temperature. The feature is accessed using MODE switch 106 to the temperature reading system.

Temperature will be displayed either in Deg. Centigrade or De. Farenheight. The user may choose between the two systems by pressing the mode switch 106. Screen 112 is updated every second for the 1 Hour time period with the option of actuating the average mode. A backlight facilitates viewing the display in a dark environment. It is enabled for as long as the light switch is held. Backlighting is accomplished using Light Emitting Diodes or an Electrical Luminescent material.

The circuit operation of unit 100 is as follows: The object of this design is to provide 0.1% pressure resolution and +/−0.5% accuracy in the full scale pressure range of the gauge. The key to the performance of this gauge is the use of a silicon pressure sensor that, while having a highly variable offset and sensitivity, is relatively linear. A microcomputer is used to zero the offset for each reading. It also applies a calibration factor to correct for the sensor sensitivity and the tolerance of the other components such as the integrating capacitor, the amplifier and the comparator.

The pressure is sensed by a silicon bridge pressure transducer. The sensor output is amplified by a standard instrumentation amplifier configuration using three operational amplifiers. Resisters set the gain and the offset in such a fashion so as to assure that even if the offset of the sensor is at the worst case end of the specification, there will be a positive signal to measure. Power to the sensor and the amplifier is controlled by the microcomputer so as to apply power only when a reading is being taken. A capacitor provides a local bypass for this power.

To achieve the desired resolution an integrating ADC (Analog to Digital Converter) is used. The ADC consists of a resistor and a film capacitor feeding a comparator. The charging and discharging of the integrator is controlled by the microcomputer.

The usable input range of the comparator and amplifier is limited therefore, the integrator capacitor is first charged to the full supply voltage, the time for the capacitor to be discharged is measured by the microcomputer. A resistors network provides a small amount of hysteresis to keep the comparator from oscillating at the transition. The transition of the comparator is fed to the microcomputer capture timer input.

The capture function in the microcomputer allows precise timing because the timer value is captured at the transition even if the microcomputer is otherwise occupied.

Temperature compensation of the pressure sensor is achieved using a thermistor with a resister. The temperature sensor is powered by the microcomputer when a temperature reading is taken. To keep the pressure sensor output from affecting the temperature reading, the signal from the pressure sensor is eliminated by grounding it using a microcomputer port pin.

A limiting resistor protects the output of the op amp and prevents excessive power supply drain.

The battery voltage is sensed through a high impedance resistor divider network to minimize the load on the battery to about 2 uA. This network keeps the battery voltage within the input range of the measuring operational amplifier.

The amplifier is coupled to the ACD input through two resistors. One resistor allows the output to be shorted to ground thus disabling this signal. The other resistor buffers the ADC input when this signal is disabled.

When a voltage reading is to be taken, the power to the thermistor is turned off. The output of the pressure amplifier is shorted to ground and the battery signal is allowed to the ADC. When the battery voltage is not being read the output of the amplifier is disabled to keep it from influencing the other readings.

Power is supplied from the batteries through a 4 Volt regulator which has very low quiescent current to minimize battery drain. Bypass capacitors keep the regulator stable.

The sounder is driven directly from the microcomputer by it generating a 4 kHz square wave signal.

The clock for the microcomputer is generated with a ceramic resonator with its two associated capacitors and the relevant circuits in the microcomputer to form an oscillator.

The microcomputer reset circuit consists of a pull up resistor and a switch. This switch enables the unit to be turned On and Off. When the switch is closed and released, the microcomputer is reset. Flags are set up in the microcomputer which indicate the desired state of functionality, i.e. On or Off, such that when it is reset the relevant state is entered into.

Four other switches provide extra functionality to unit 100:

1. One switch provides an Averaging or Mode function in which the readings are sampled, averaged and the display updated less frequently than in standard mode. This switch also enables the zeroing feature for the user. When the unit is turned on, with this switch pressed at the same time, the meter is zeroed to the ambient pressure and temperature.

2. The second switch gives a backlight function for the display.

3. The third switch gives a peak hold function where the highest reading is updated to the display.

4. The fourth switch is multiplexed to the sounder output.

Display 112 is a two-level multiplexed LCD. The display segments are driven by the microcomputer or microprocessor (a single or multiple microprocessors are used herein). The two backplanes are driven in a half bias fashion. To provide the intermediate voltage on the backplane lines resistor networks form a pair of voltage dividers. The timing of the drive signals from the plane and segment drivers is such as to provide a signal that is out of phase with relation to the backplane voltages for segments that are to be turned on and a signal that is in phase for segments that are off. This also conforms to the requirements that there be AC signals only on each segment. The timing is critical so the display is turned off during A/D conversions so the AC waveforms are not interfered with by the reading processes.

Test and calibration features of the invention are as follows: The test system is driven by an ADC and digital I/O card in a platform computer. A series of tests and measurements are performed. Calibration factors are calculated and then programmed into the EPROM in the microcomputer on the gauge. The test system consists of a program running on the platform computer and a test procedure in the pressure gauge that interact to provide a series of measurements to test the gauge performance and support the calculation of calibration factors.

The first test is to verify that the voltage regulator is functioning within limits. Then the microcomputer is taken out of reset with a voltage applied to the op amp power rail. This invokes the test software or firmware in the microcomputer. The transition from one test to the next is caused by raising and lowering the voltage on one of the microcomputer pins. The tests include taking a zero pressure reading, a temperature reading, a battery voltage reading and a reading from applying a known voltage to the ADC with the other sources disabled. Then a standard pressure is applied and readings taken. For the zero pressure, reference voltage, and the test pressure, the digital value measured by the microcomputer is read out by clocking the microcomputer pin and reading the data on a second pin, one bit at a time.

The calibration table for the pressure readings consists of a piece-wise linear model of the exponential curve of the RCA integrating ADC. There are 55 table entries that are calculated from the test readings as well as calculated values of a calibration factor for sensitivity and low battery voltage as well as a fixed temperature compensation factor are set up in an array.

There is provision for four sets of calibration factors. A byte in the beginning of program memory is used to indicate which tables are available. A bit is programmed for each table used. The microcomputer is put into programming mode by raising the reset line to 12 Volts. The memory table byte is first read. This directs the PC program as to how many memory locations to index before starting the programming process. Each byte is verified after programming.

Each test is reported on the screen. Only if all of the tests are passed does the programming proceed. Any failure designation should point to the section of the circuit as described above. The pressure sensor wring is particularly fragile. A failure of the pressure offset or pressure test will often be due to a broken wire or a solder short. This can be traced by looking at the two output lines. No voltage on either of them suggests that the supply line is open. Likewise, both high suggests that the ground line is open. If one line is at around 2 Volts and the other is high or low, there is an open or short on that line.

Unit 100, the routines associated with the mode of operation of the unit and the circuitry provide unique features that include unlimited mobility and portability (where a battery is used herein a rechargeable, portable energy source is used); unit 100 covers a multitude of applications using the same gauge assembly with a variety of different adapters. Other unique features include the remote transducer of the present invention; remote altitude compensation (real-time); remote temperature compensation; 3 or 4 digit display on display 112; automatic and continual conversion to KPa and PSI; temperature measurement using the same probe assembly; and the backlight feature described above.

Unit 100 includes a power saving mode of operation. In this mode of operation unit 100 turns off after a predetermined time when reading less than 0.5% of full scale (5 Minutes). Unit 100 turns off after a predetermined time (1 Hour). As described above, the different modes of operation include a regular mode of operation, an averaging mode of operation, a peak hold mode of operation, a pressure sensing mode of operation, and a temperature sensing mode of operation. Unit 100 provides the advantage of being accurate to 0.5% over its full range or measurement.

Another unique feature of unit 100 includes the fact that housing 116 of unit 100 is manufactured of aluminum. This feature provides the unit with excellent RFI and EMI shielding properties, lightness of weight, and creates a very sturdy damage resistant unit 100. Unit 100 is also ergonomically shaped and dimensioned to readily fit into the palm of the hand of a user. By way of example, the height H of the top portion of unit 100 in preferably in the range of about 1.8-2.5 inches, the width W of the top portion of unit 100 is in the range of 2.5-3.5 inches (FIG. 2). Bottom portion B of unit 100 (FIG. 2) is generally dimensioned to readily fit into the palm of an adult male/female and be readily grasped thereby. The depth D of unit 100 is preferably in the range of 0.5 to 1.0 inches. These dimensions are only exemplary and other dimensions are also contemplated herein.

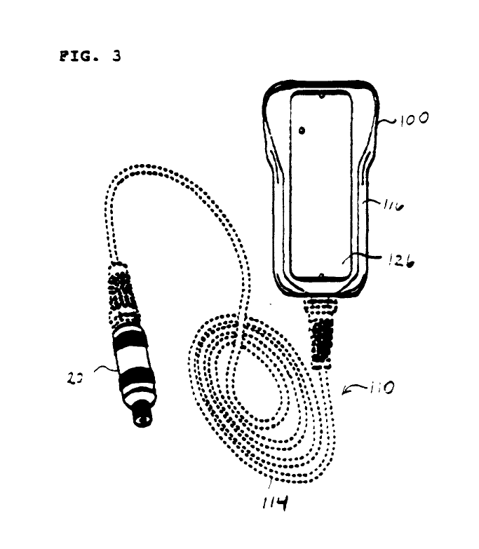

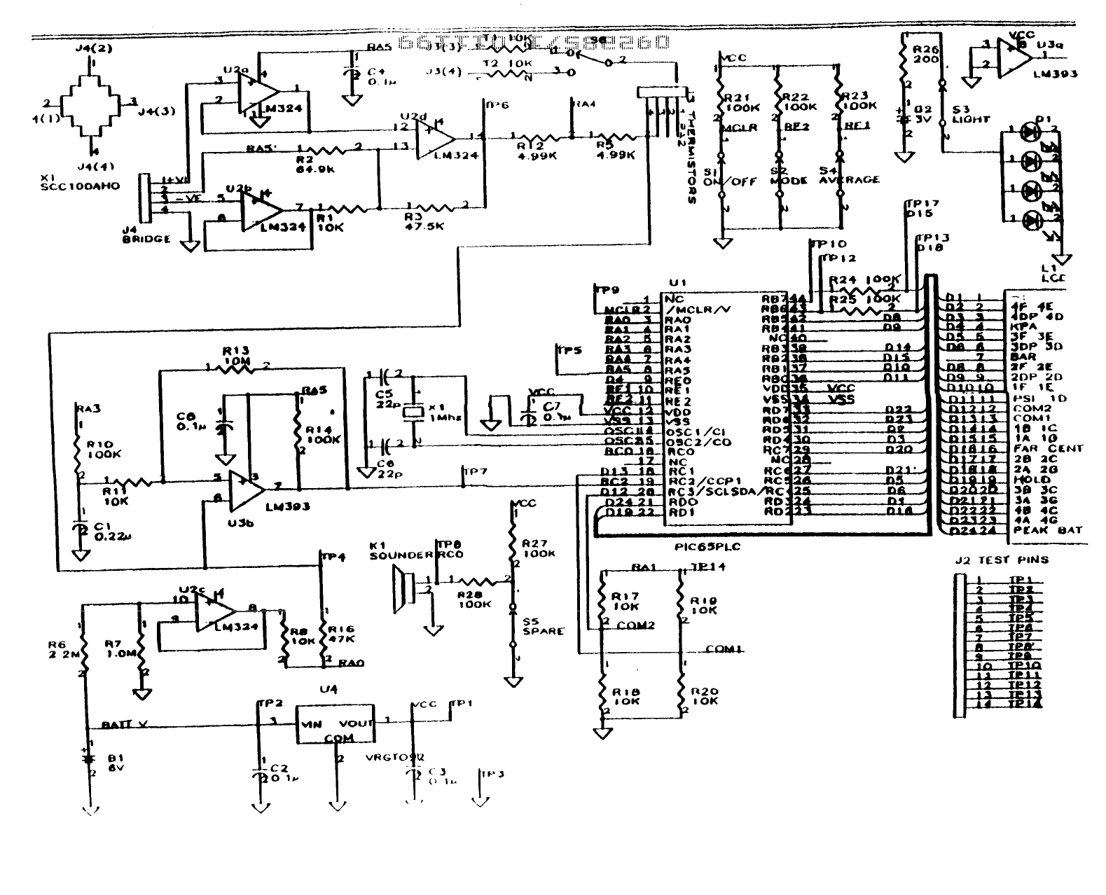

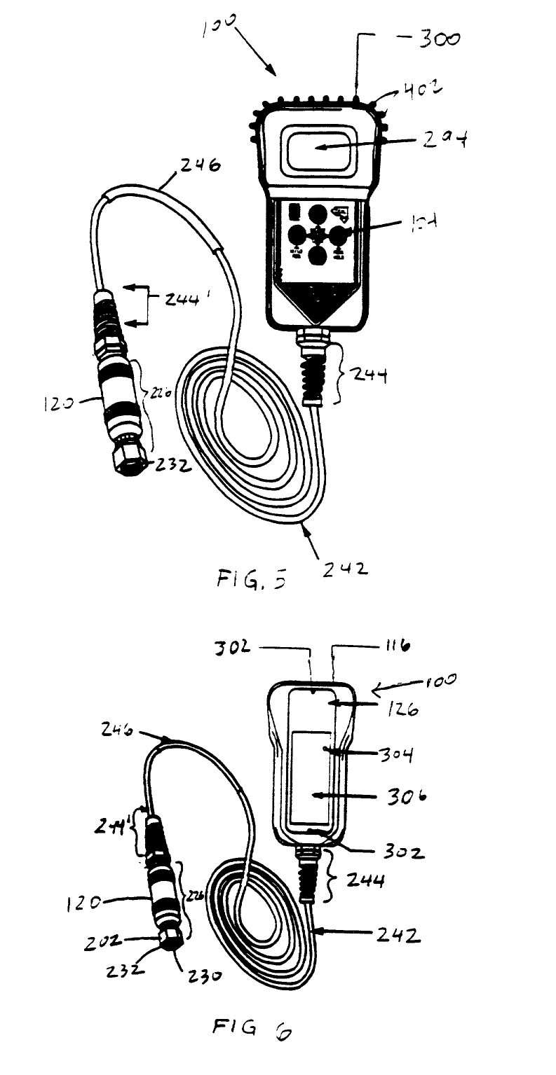

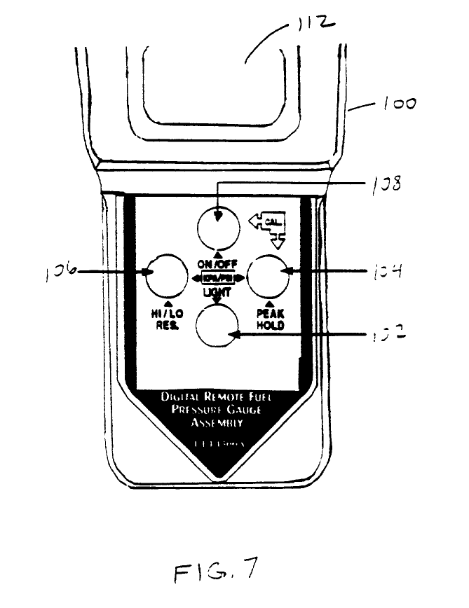

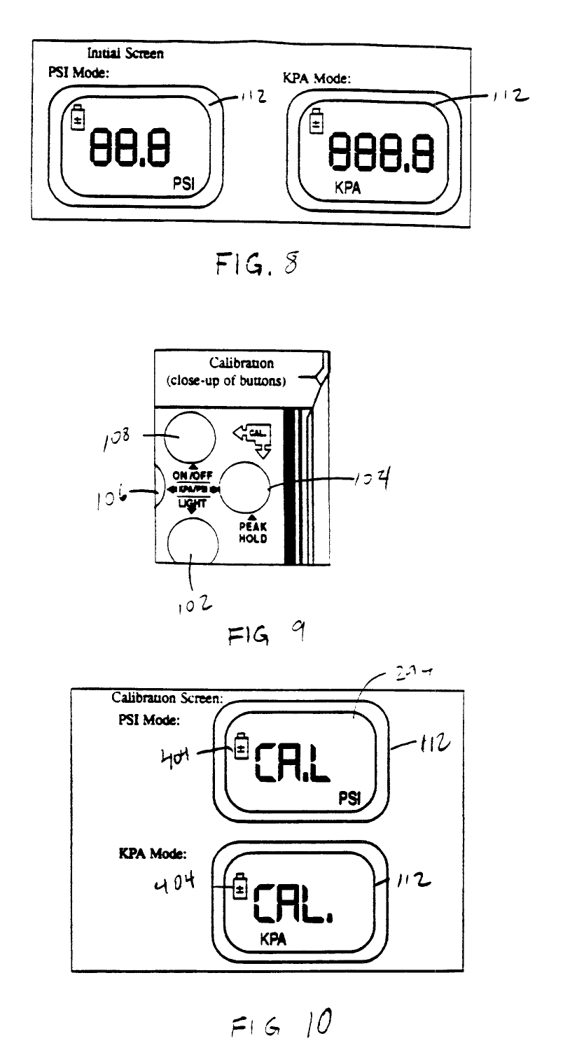

Optionally, casing or housing 116 is anodized to give a visually appealing finish and added durability. Unit 100 further includes an optional magnet 126 (FIG. 3) on the back of unit 100 that facilitates sticking or removable retention of unit 100 to ferrous surfaces that include tool boxes, automobile components, and the like.

Optional features of the invention includes the ability to measure pressures up to 4000 PSI, the addition of vacuum measurements, RS232 (or other communication to a host computer (not shown), the utilization of multiple units 100 in the same package of kit, the use of a communication link that utilizes telemetry between the remote probe 120, and the gauge assembly unit 100, and/or a remote personal computer.

The present invention also includes a Digital Remote Gauge assembly kit that is packaged in a variety of different formats and that includes unit 100, a communication link 114, and a plurality of probes, e.g. probe 120, and other probes for measuring external parameters. The kit includes, but is not limited to, a combination of different kits which include a variety of different adapters suited to taking readings from different sources utilizing different source ports.

The kit includes sensors or probes that are compatible with different sources of pressure that include, but are not limited to, oil pressure, air pressure, transmission fluid pressure, power steering fluid pressure, brake line pressure, fuel injection pressure, and/or combinations thereof. The various adapters that are used in the kit of the present invention include, but are not limited to, Swivel Female JIC adapters, Air pressure (Schrader valves) adapters, NPT fittings, and other adapters known in the art. It is further appreciated that the unit provides for increased measurement sensitivity at low cost.

FIG. 4 illustrates an electrical schematic of the digital remote gauge assembly 100 of FIGS. 1-3. The key to the performance of gauge 100 is the use of a silicon pressure transducer SCC100AH0 that, while having a highly variable offset and sensitivity, is relatively linear. The silicon pressure transducer is commercially available from Sensym, Inc. of Milpitas, Calif. The microcomputer U1 is used to zero the offset for each reading and also applies a calibration to correct the sensor sensitivity and the tolerance of the integrating capacitor C8, the op amp U2c and the comparator U3b.

The pressure is sensed by a silicon bridge pressure transducer SCC100AH0 connected to J4. The transducer SCC100AH0 output is amplified by a factor of about 14 in a standard instrument amplifier configuration using U2a, U2b, and U2d which are three sections of an LM324 quad op amp.

Resisters R1, R2 and R3 set the gain where R2 also provides an offset to assure that even if the offset of the sensor is in a worst case state there will be a positive signal to measure. This offset is set to about 600 mV to cover the specified 32 mV offset multiplied by the gain of the amplifier U3b plus an additional margin. Power to the sensor and the amplifier is controlled by the microcomputer U1 port pin RA5 to apply power only when a reading is being taken. Capacitor C4 is a local bypass for this power.

To achieve the desired resolution, at low cost, a simple integrating analog to digital (A/D) converting circuit is used. The A/D circuit consists of resistor R10 and a film capacitor C1 feeding comparator U3b. The charging and discharging of the integrating circuit is controlled by microcomputer U1 port pin RA3. Because the usable input range of the comparator U3b and amplifier U2d is from 0 to 2.5 Volts from the 4 Volt power supply. The integrator capacitor C1 is first charged to the full supply voltage. The time for the capacitor C1 to be discharged is measured by the microcomputer U1. Resistors R11 and R13 provide a small amount of hysteresis to keep the comparator U3b from oscillating at the transition point. The transition of the comparator U3b is fed to the microcomputer U1 port pin RC2 which is the capture timer input. The capture function in the microcomputer U1 allows precise timing because the timer value is captured at the transition even if the microcomputer U1 is otherwise occupied.

To provide temperature compensation, of the pressure sensor SCC100AH0, a thermistor T1 is used along with resister R5 as divider. An attachable temperature sensor connected to J33 and J34 is powered by microcomputer U1 port pin RA2 when temperature reading is taken. To keep the pressure sensor SCC100AH0 output from affecting the temperature reading, the signal from the pressure sensor SCC100AH0 is eliminated by grounding it using microcomputer U1 port pin RA4. Resistor R12 protects the output of op amp U2d and prevents excessive power supply drainage.

Battery B1 voltage is sensed through a high impedance resistor divider consisting of R6 and R7 to minimize the load on the battery B1 to about 2 uA. This divider keeps the battery voltage within the input range of op amp IC2d. The battery voltage amplifier U2c is coupled to the A/D circuit input through resistors R8 and R16. When a voltage reading is to be taken the power to the thermistor T2 is turned off by switch S6, making RA2 an input. The pressure sensor SCC100AH0 is shorted with RA4, and RA0 is made an input to allow the battery signal to the A/D circuit. When the battery voltage is not being read, RA0 is made a low output to keep the output of the battery voltage amplifier U2d from influencing the other readings.

Power is supplied from battery B1 through a 4 Volt regulator U4 which has very low quiescent current to minimize battery drain. Capacitors C2 and C3 keep the regulator stable. Further, power is supplied to microcomputer U1 port pin 1 via Comparator U3a serving as a current source.

The sounder is driven directly from the microcomputer U1 through port pin RC0. The microcomputer U1 generates a 4 kHz square wave signal to drive sounder K1.

The clock for the microcomputer is generated by a 1 Mhz ceramic resonator X1 along with capacitors C5, C6 and circuits in the microcomputer to form an oscillator driving microcomputer U1 port pins OSC1/C1 and OSC/C0.

The microcomputer reset circuit consists of pull-up resistor R15 and switch S1. At the end of each reading cycle, the microcomputer U1 is put in sleep mode which is a very low power consumption mode. When the switch S1 is closed and released, the microcomputer U1 is reset and starts a new cycle.

Switches S2 through S5 provide extra functionality to this invention. Switch S2 provides a function to which to accesses alternate features such as temperature reading options. Switch S4 enables an Averaging mode on which the readings are sampled, averaged and the display is updated approximately 10 times less frequently than in the inventions standard operating mode. S4 gives a Backlight function for the LCD display L1. Switch S5 is multiplexed to the sounder output and has yet to be defined. Switch S3 turns on LEDs D1, D2, D3 and D4.

The display L1 is a two-level multiplexed LCD, having a first plane and a second plane, whereon each plane has predefined plane lines. The display segments are driven by microcomputer U1 port pins RB0 to RB7 and RC5 to RC8. The two planes are driven by RC1 and RC3. To provide the intermediate voltage between on the planes lines, resistors R17 to R20 form a pair of voltage dividers. Ports Com1 and Com2 provide RS232 communication with an external device. It is further appreciated that a wide range of temperatures and pressures can be measured utilizing the present invention.

Before connecting fuel line and JIC fittings, a few drops of clean engine oil are applied to JIC ends to ensure proper connection with female connectors. Whenever connecting or disconnecting from a fuel system, a shop towel is optionally used to catch any fuel that may leak out of line or JIC fittings and the towel is disposed of in approved container when finished. If leakage is observed during testing with gauge 100, the ignition is turned off or foci pump is disabled and foci pressure is relieved, if necessary. Spilled fuel is wiped up and leaks are connected before continuing. When using hose adapters, hose is secured with hose clamps to ensure leak-free connections.

With respect to reading temperature gauge 100 comes with the capacity to read the temperature (°C. or °F.) of the fluid being tested. Gauge 100 utilizes heat passive alloy in the construction of probe assembly 226. Several minutes pass for the temperature of the fluid sensed to reach the temperature sensing element in probe body 120 and a lag time in reading a response is experienced. Allowance for this lag time is made before reading temperature.

Assembly 100 has been calibrated for pressure and temperature. This procedure allows for the use of oil. Threaded cap 230 has been provided on probe end 232 to prevent leakage of excess oil. Cap 230 must be removed before attaching gauge 100 to a manifold.

The digital remote fuel pressure gauge assembly 100 provides a technician with an accurate and efficient method of testing a variety of program applications on cars and light trucks, remotely displaying system pressure while a vehicle is being driven. For the digital remote fuel pressure gauge assembly 100 to be useful, the technician must be able to read the pressure while the vehicle is driven under load. Pressure gauge 100 gives the technician the ability to duplicate the problem the customer has described and see the problem firsthand. This reduces the guesswork when diagnosing system pressure problems.

Gauge assembly 100 displays pressure readings from 0 to 100 PSI (pounds per square inch) in increments of tenths of a PSI, or in the equivalent KPA (Kilo Pascal) measurement. The accuracy is about 1% over the full temperature range. Gauge 100 is microprocessor 234 controlled, and is temperature and altitude compensated. Digital remote fuel pressure gauge assembly 100 has the capacity to read the temperature of the fluid being tested in either °C. or °F.

Some typical applications where the digital remote fuel pressure gauge assembly will provide a revolutionary method of reading pressure are in reading oil pressure, air pressure, fuel line pressure and coolant pressure. Assembly 100 gives the technician the ability to have the vehicle test driven and gather the information needed to diagnose the problem without time consuming and costly guesswork.

Digital remote fuel pressure gauge assembly 100 provides a unique ergonomically designed case made of anodized aluminum, is accurate to =1% over the working pressure range of 100 PSI, 1/Loth psi resolution, provides surface mount technology that offers a high degree of reliability, is microprocessor 234 controlled, is temperature and altitude compensated, has a polarized LCD display 112, features KPA/PSI conversion, provides a peak hold feature, provides a HI/LO resolution feature that allows instant or averaged sampling control, provides an electroluminescent backlight, low battery indicator, 2 lithium coin cell batteries for about 120 hours of sustained use, and reads temperature of fluid being tested in either °C. or °F. Digital remote probe assembly includes JIC quick disconnect with fittings and a coupler allows quick and easy attachment to adapters shown herein, and is made of a rugged heat passive alloy 238.

The pressure transducer is temperature and altitude compensated when used in conjunction with digital remote fuel pressure gauge 100. Gauge 100 provides rapid engine installation, via multi-conductor shielded cable 242 (which can be in the range of five to twenty feet in length) is connected to hand-held gauge 100, cable 242 allows monitoring from within the vehicle. Rugged strain relief members 244, 244′ make probe assembly 100 extremely durable. Sliding protective cable sleeve 246 protects cables 114, 242 when passed through the passenger window during remote use. Multi-conductor cable 114, 242 is constructed to withstand a temperature range of −20° F. to 280° F. continuously.

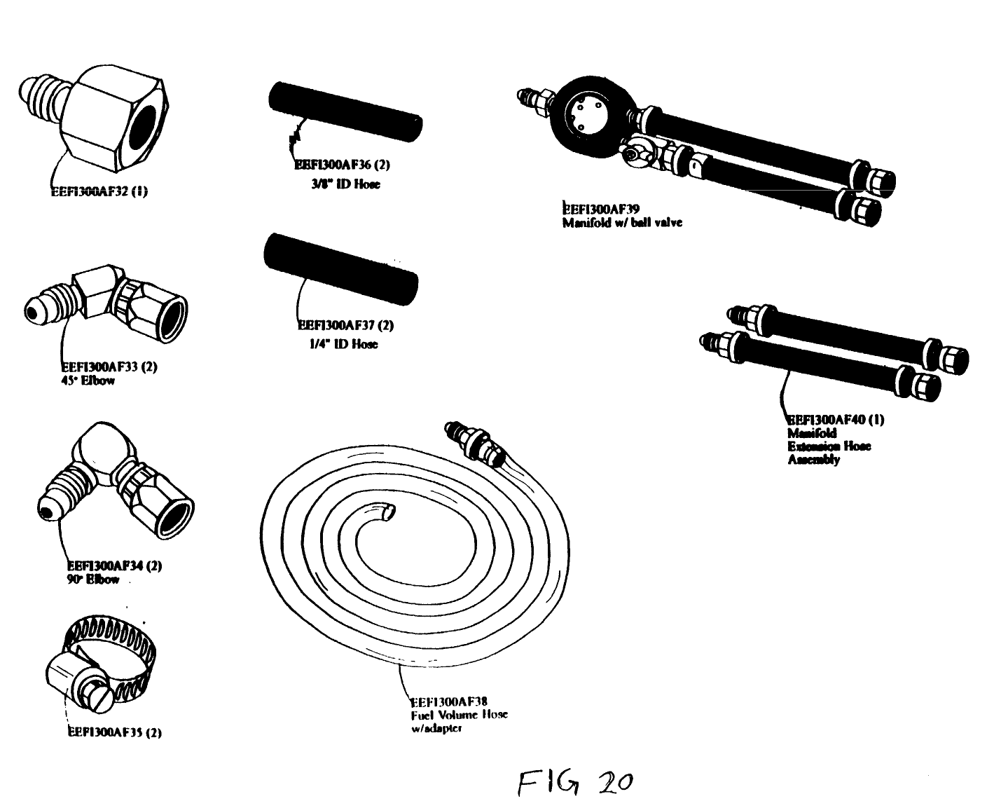

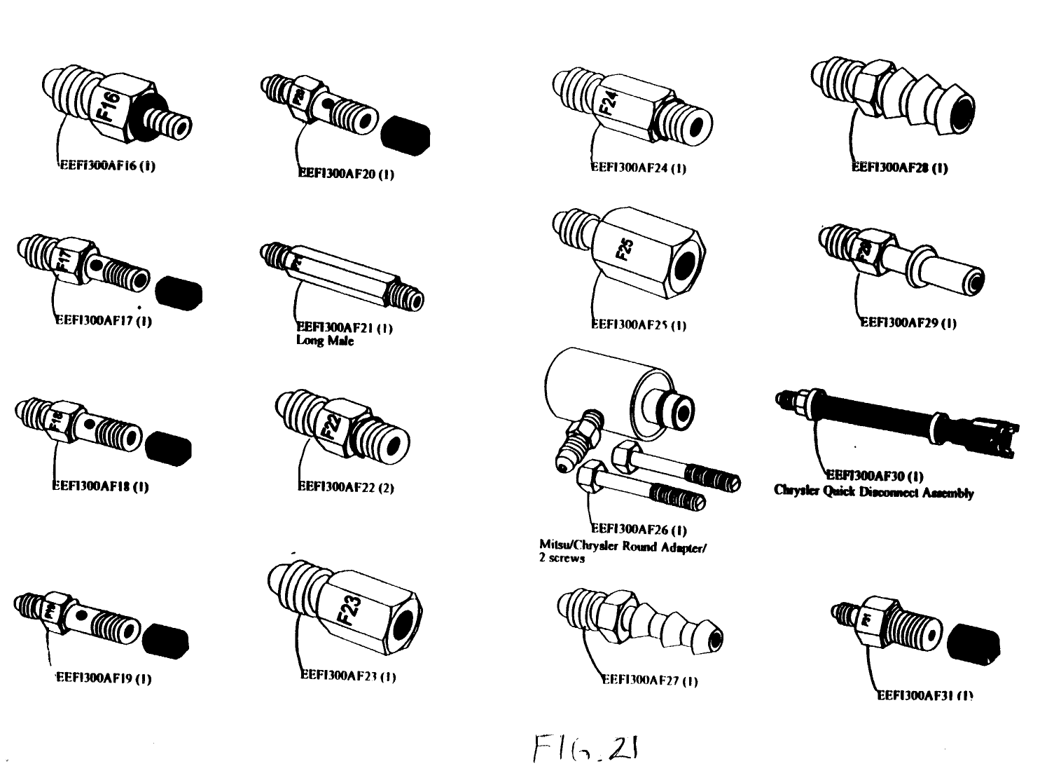

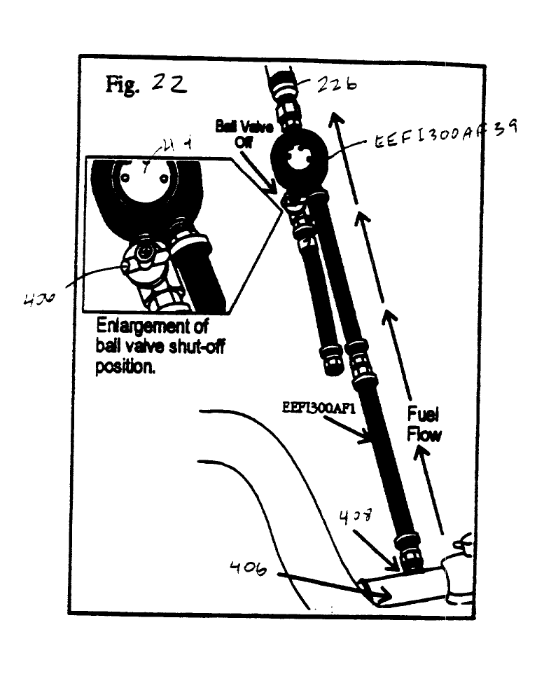

Gauge assembly 100 provides adapter kits the parts of which are illustrated in FIGS. 19-21. The adapter kits are designed for use with digital remote fuel pressure gauge 100. Kits include hoses, quick disconnect couplers and adapters, both male and female, needed to access the fuel supply of the fuel injection systems for each particular kit. Kits also includes a vehicle application look-up tables 256 (attached hereto as Appendix A), outlining specific guidelines for the application and usage of the manifold (FIGS. 22-25) and adapters 254 for the kit 256. Vehicle look-up tables 256 include make, model and years for easy vehicle identification, as well as the pressure readings needed for the particular vehicle.

Several kits are provided including a grand master kit with digital remote fuel pressure gauge 100. Kit is the most complete and versatile adapter kit available. Domestic master kit includes a combination of adapters to access all domestic fuel injection systems on vehicles from 1980-86. Foreign master kit includes a combination of adapters to access all import fuel injection systems on vehicles from 1977-96. Domestic basic kit includes adapters needed to access most domestic fuel injection systems on most GM/Saturn Ford and Chrysler vehicles. Foreign basic kit includes adapters (FIGS. 19-21) needed to access most foreign fuel injection systems including: Geo, Honda, Hyundai, Infiniti, Isuzu, Mazda, Mitsubishi & Nissan.

Optional accessories include knee board attachment (not shown) that allows the user to hold and read gauge 100 with hands free to make notes on the attached pad, air chuck, a snap-on adapter quick disconnect to JIC converters, ⅛″ NPT to JIC for snap-on gauge conversion, a 1 liter bottle used for volume testing, and 2 snap-on quick disconnect to snap-on FI Series adapters.

Gauge assembly 100 includes a number of commands and modes of operation. The PSI mode is one in which the LCD screen 112 shows a pressure read in PSI (pounds per square inch) measurement. The KPA mode is one in which the LCD screen 112 which shows a pressure read in KPA (kilo pascal). The PEAK HOLD mode is a function of the unit which is displayed on LCD screen 112 and shows the highest pressure read during the sample taken. The HI/LO RES (Resolution) mode is a function of the unit which is displayed on LCD screen 112 and gives the technician a choice of LO RES which shows the average pressure from a sample of 8 consecutive readings or HI Res which shows the ranging of the pressure in the fuel system in real time. The Temperature mode is a function of the unit which reads the temperature of the fluid being tested in either °C. (Centigrade) or °F. (Fahrenheit).

FIGS. 1 and 5 are a front view of gauge assembly 100. Gauge assembly 100 includes gauge body 116 which is an anodized aluminum casing which houses microprocessor 234, internal electronics 292 (FIG. 4) and LCD window 294 of display 112. Other appropriate materials may also be used to construct gauge body such as rugged and durable plastics and the like.

LCD Screen 112 includes a liquid crystal display which shows pressure in 0-100 PSI increments of tenths of a PSI, or in the equivalent KPA measurement. Temperature can also be displayed here in °C. and °F. Screen 112 shows a steady display when in LO RES Mode and blinks when in HI RES Mode.

Function buttons 102, 104, 106, and 108 include 4 pressure sensitive rubber buttons which access unit 100 functions. Strain relief is provided by a pliable, water-resistant seal 296 which protects connection between cable 114 and gauge body 116 and/or probe assembly 120. Cable 114 is a 12 foot multi-conductor shielded cable between gauge body 116 and probe assembly 120 in one variant which gives unit 100 the convenient required distance between actual test position and read-out. Probe assembly 100 is made of a heat passive alloy, assembly 100 houses pressure transducer 240 and temperature compensation component 298; complete with JIC connector.

A durable and pliable protective sleeve 246 is provided for the protection of cable 114 when unit 100 is used remotely. Sleeve 246 slides along cable 114 to enable it to be positioned where the window of the passenger side window closes on the cable when the unit is being used to read pressure while test driving this vehicle. A removable protective boot cable sleeve 300 made from a molded case of black PVC material is provided to add protection to the gauge body 116. Boot 300 is molded to fit gauge body 116 snugly and designed for a comfortable and effective hand grip.

FIG. 6 provides a back view of gauge 100 with boot 300 removed. Boot 300 is illustrated in FIG. 5 and includes a number of gripping protuberances 402. A battery cover includes removable plate 126 which unscrews at: screws 302 to allow access to replace the 2—#CR2032 lithium coin cell batteries which are located inside body 116. Other battery sources of power are also contemplated herein.

Screws 302 hold gauge body 116 together, and are removed during battery replacement. Piezo buzzer opening 304 is an opening from which audible “buzzer” sounds emanate. Optional magnet 306 enables gauge body 116 to adhere to any convenient magnetic surface and to attach unit 100 to where it best suits use. Magnet 306 is applied to back of boot 300.

On/Off button 108 is used to turn unit 100 on and off, and is also used in conjunction with Peak/Hold button 104, to calibrate. Peak/Hold button 104 activates the Peak/Hold Mode and aids in calibration. Button 104 aids in choosing a PSI or KPA Mode for display of pressure readout and in accessing Temperature Mode. HI/LO Res button 106 activates the HI/LO Resolution Mode and aids in choosing the PSI or KPA Mode for display of pressure readout and is used in accessing Temperature Mode. Light button 102 illuminates LCD screen 112 for easy reading when visibility is poor.

General usage instructions for gauge 100 are as follows: A user turns the digital remote fuel pressure gauge 100 ON by pressing button 108 once and releasing it. Unit 100 will then make an audible ‘beep’. Gauge 100 turns on and displays one of the following screens on LCD screen 112 for one second (the screen shown indicates either PSI or KPA) (FIG. 8). The PSI Mode displays 3 digits and a decimal point for readings over 99.9 (same as KPA display).

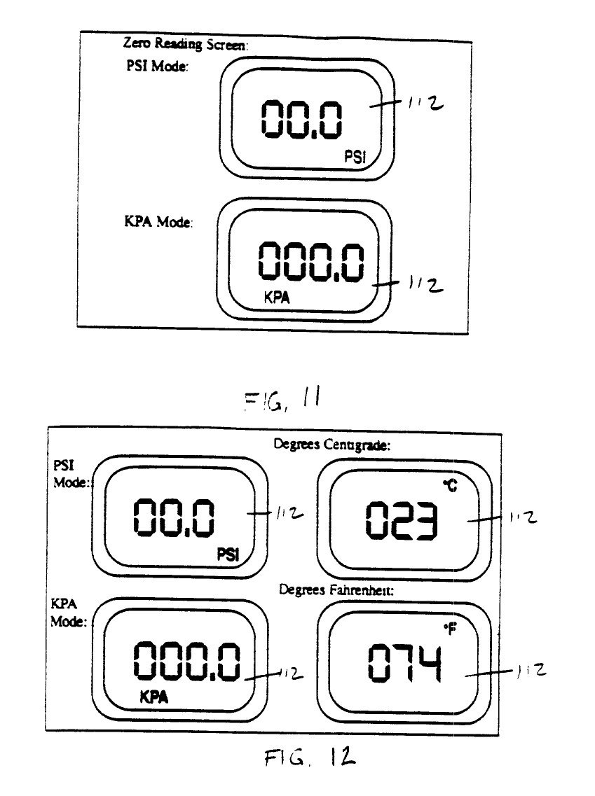

LCD screen 112 shows a zero reading (the placement of the decimal point will be determined by the mode the screen is in) (FIG. 11). If screen 112 does not show a zero reading, calibration of the unit is recommended. Unit 100 will start up in the LO Res (Average) Mode and will show a continuous display until other modes are chosen. To turn the unit off the user presses button 108 once and releases it. The display 112 will be blank, and the unit is now off.

To calibrate digital remote fuel pressure gauge 100, a user initially calibrates unit 100 in order to compensate for altitude. To calibrate gauge 100, the unit is turned off, button 104 is depressed and held. Unit 100 is turned on by depressing both buttons 108 and 104. Button 108 is then released while continuing to hold button 104. Display 112 will show one of the following screens as shown in FIG. 10 (the screen shown will be determined by the mode currently chosen).

Now button 104 is released. Screen 112 shows a zero reading screen (the position of decimal point will be determined by the mode the screen is in). LCD screen 112 displays one of the following screens as shown in FIG. 11. Unit 100 is now calibrated to ambient temperature and altitude (temperature will be automatically calibrated). A user is now ready to read accurate pressure. A low battery symbol 404 shows during the calibration sequence, indicating that the low battery test has started.

Unit 100 includes an automatic temperature compensation function. Unit 100 automatically compensates for temperature while a user uses gauge assembly 100. This automatic temperature compensation is provided by the microprocessor (FIG. 4) to maintain accuracy over the temperature range. As the engine compartment heats up where probe 226 is located and the temperature increases, changes to the sensing ability of pressure probe 226 will occur. To compensate for the environment pressure probe 226 will have to endure, this temperature compensation feature has been added to maintain the accuracy of the gauge. Temperature compensation is an added feature of the digital remote fuel pressure gauge 100.

Use of the digital remote fuel pressure gauge 100 is straight forward. Turn unit 100 on and determine if calibration is needed. (This is indicated in LCD screen 112 if screen 112 does not display a zero reading). If screen 112 shows a zero reading a user is ready to continue. Unit 100 is periodically recalibrated, possibly once each day unit 100 is used. Frequent recalibration will not harm unit 100. It is not necessary to recalibrates each time unit 100 is turned on, even though barometric pressure might change. If very accurate pressure readings are desired, recalibration is recommended.

A user enters a PSI or KPA Mode and an Access Temperature Mode. While unit 100 is on, a user presses and holds both buttons 106 and 104 (FIG. 13) for one second and then releases both buttons. The window 112 will display a blank screen except for the designation of the mode (PSI in the lower right or KPA in the lower left, °C. or °F. in upper right). A numerical value will not show until a user has chosen the mode. Button 104 (FIG. 13) is used to select the desired unit of measurement (PSI or KPA) and to access the Temperature Mode (°C. or °F.). Each time button 104 is pressed and released display 112 will toggle between the 4 screens in sequence (KPA, °C., °F., PSI, KPA, . . . ). When LCD window 112 shows the desired screen, depress and release Button 106. This will hold the screen in the desired method of measurement or temperature.

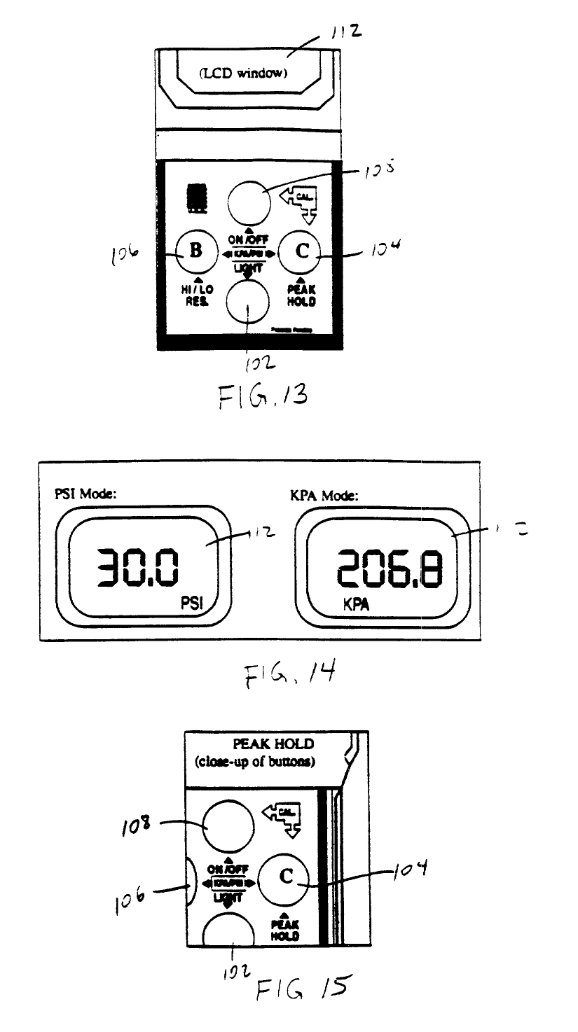

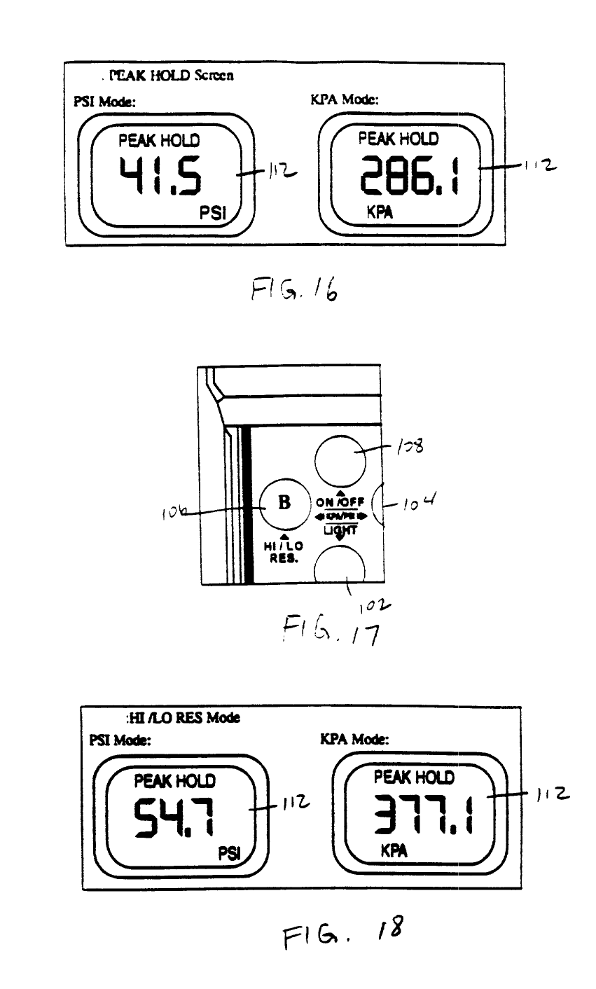

FIG. 13 is a close-up of buttons of gauge 100. When in PSI or KPA mode screen shows the zero reading in the chosen mode and a user is ready to read pressure in that mode (FIG. 12). To change screens (from PSI to KPA or for temperature) the procedure is repeated; a user presses and holds buttons 106 and 104 together (FIG. 13), then releases them. The user presses and releases button 104 (FIG. 13) until the desired screen is shown, then presses button 106 (FIG. 13) to hold the screen. These settings can be changed during use without affecting the calibration. If switching the mode while already reading pressure on the gauge, the screen will not show a zero reading but will indicate the current pressure reading being taken. The samples on the following page are of possible readings when this is done (FIG. 16).

The Temperature Mode will be activated as soon as the screen is chosen and temperature will show on the screen as sensed by probe 226 (FIG. 11) in the chosen method (i.e. °C. or °F.).

After setting digital remote fuel pressure gauge 100 to the desired mode of measurement, a user connects probe end 120 into the appropriate adapter (FIGS. 19-21). A user is now ready to read pressure/temperature. Screen 112 shows the pressure/temperature in the mode the user has selected (PSI, KPA, °C. or °F.). Gauge 100 takes a pressure/temperature sample approximately once each second.

A user can now choose to use the PEAK HOLD or HI/LO RES mode for normal function, depending on the application needed. Temperature continues to be taken as long as either the °C. or °F. screen is activated. The automatic shut-down feature of unit 100 does not activate from either of these screens. A user manually shuts off unit 100 to save battery life, or switches to another mode and the automatic shut-down feature will activate as described herein.

A user can select a PEAK HOLD Mode, LCD screen 112 will display the highest reading sampled while in this mode (FIG. 16). This mode would be used while testing the engine under load. Since the highest reading is retained, gauge 100 does not need to be visually monitored continuously.

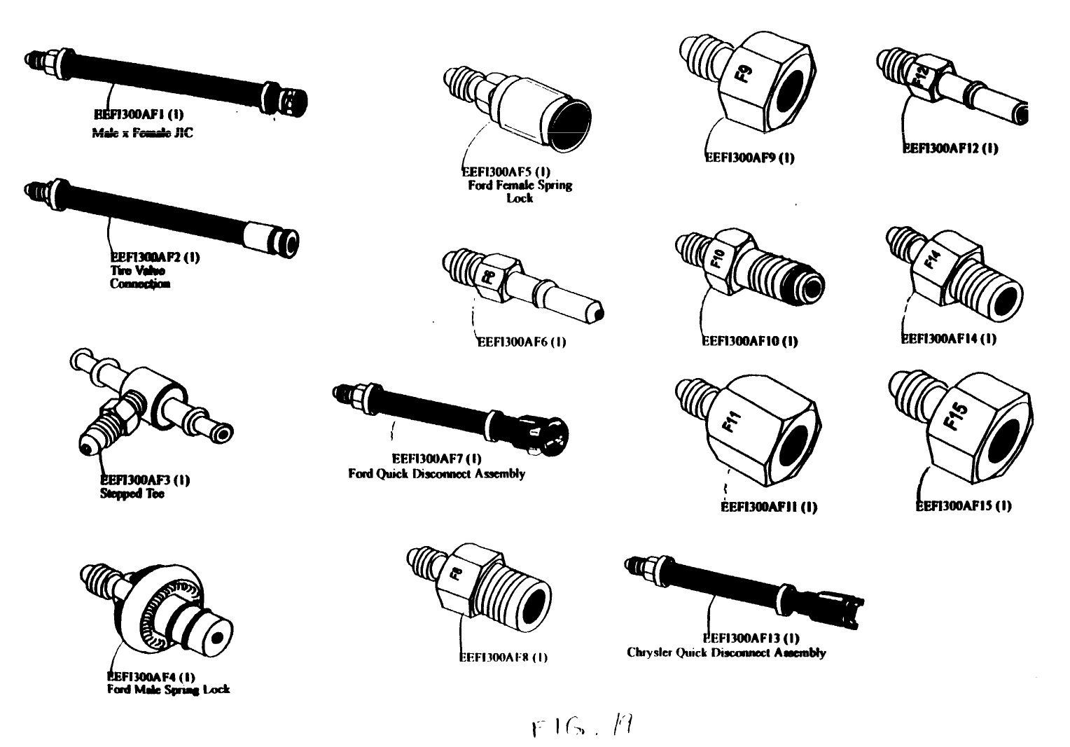

To use the PEAK HOLD mode, a user presses the following series of buttons: While unit 100 is on and pressure readings are being taken, a user presses and releases button 104 (FIG. 15). Gauge 100 now retains the highest measured reading and the words PEAK HOLD will show on LCD screen 112 (FIG. 16). An audible ‘beep’ will sound with each new peak reading achieved. Unit 100 will continue to read and display the current peak reading as long as PEAK HOLD mode is operating. The words PEAK HOLD will only be visible on the screen when PEAK HOLD mode is activated. PEAK HOLD mode is accessible from either screen.

A user can select a HI/LO RES Mode of gauge 100. When the digital remote pressure gauge 100 is first turned on, it is in low resolution or standard operating mode. The pressure is being sampled at approximately 1 second intervals. Unit 100 will average 4 samples, displaying that average pressure on the screen in 0.5 PSI increments to give a more stable reading. Screen 112 updates this information every 4 samples. If a user wants to read real time pressure, he uses the HI RES mode (FIG. 17). If the user would like a stable reading, a user uses the LO RES mode. These Modes provide for provider sampling of pressure.

When in the HI RES Mode, LCD screen 112 blinks. This blinking will indicate that the user is sampling pressure at 1 sample every second, and the screen will update display 112 with every blink. In this mode a user may notice that the fuel pressure is wandering. There is nothing wrong with the fuel pressure gauge. What the user is seeing is the pulsing of the fuel pump and the spring movement of the fuel pressure regulator. If the user lets the engine idle he will notice that the ranging will settle down and a more stable reading will be displayed. Being able to see the ranging of the fuel system in this way is a first time experience. Because of the accuracy and the rapid real time updating, a user will see how the internals of the fuel system are operating.

To use the HI/LO RES Mode of gauge 100 the user presses a series of buttons. Some situations may require the use of a faster screen update for which the HI/LO RES Mode is used. Pressing Button 106 (FIG. 17) switches unit 100 into its high resolution mode. Screen 112 blinks every time a sample is taken and it is updated with every new sample immediately. In the high resolution mode, the pressure readings will range and vary with the pressure being measured. This mode is accessible from either the PSI screen or the KPA screen and can be used in conjunction with the PEAK HOLD mode. When taking an average reading while also in PEAK HOLD mode, it is advisable to wait until the 1st audible ‘beep’ before reading the display. This enables the HI/LO RES mode to read the needed 8 samples to provide a correct average reading. Screen 112 indicates all modes that are currently activated (FIG. 18).

Gauge 100 also includes an auto turn-off feature. Digital remote pressure gauge assembly 100 continues to operate as long as unit 100 is turned on and sensing pressure. If gauge 100 is disconnected from the system under test for approximately 2½ minutes, or if the pressure falls below about ½ of a PSI (or equivalent KPA) for approximately 2½ minutes, unit 100 will give an audible ‘beep’ and shut down. This automatic shut-down feature helps to save the life of the batteries 236. The digital remote fuel pressure gauge 100 is designed to withstand the rigors of a shop environment.

The backlight feature allows the user to read screen 112 when visibility is poor. The backlight is electroluminescent. To use the backlight the user presses and holds Button 102. This will illuminate screen 112 in whatever mode is currently operating.

Gauge 100 also includes a low battery indicator feature that is a battery symbol 404 appearing on screen 112. Battery symbol 404 will be visible in the upper left of LCD screen 112 if batteries 236 are low and need replacement, regardless of mode or screen selected. The only time this visible indication does not mean battery is low is when the very first screen is visible upon turning on unit 100, and when the calibration screen is activated. When either of these screens are visible, the battery symbol will disappear from view after the changes; if it remains on the screen and continues to show on the screen then it is an indication of low batteries and replacement is recommended. During final testing and calibration, each unit is individually calibrated. The calibration data is stored in non-volatile memory within microprocessor 234. Replacing batteries 236 does not degrade the accuracy of measurement of gauge 100. Gauge 100 is useful in fuel injection trouble shooting.

Before beginning the fuel injection troubleshooting process with gauge 100 a user should be sure some of the more obvious problems have been checked. When the user has a poor running vehicle, or a performance problem, the user should plan his methodology. The symptoms of the performance problem can be specific, but there may be many causes. The user should inspect all the basics: spark plugs, wires, cap, rotor, ignition timing, compression, valve timing, air filter, transmission fluid, brake drag and check for a clogged catalytic converter by testing for excessive back pressure in the exhaust using the Back Pressure Tester (EEPV500A). All of the above can give the same poor power and performance symptoms as a fuel injection problem.

Once a user has determined that the above elements are in good condition and set to the proper specifications, the user should next check the fuel injection system. As standard practice, and as part of the fuel injection troubleshooting process, the user looks at the fuel filter. If there are any questions as to the age or condition of the filter, the user changes it and test drives the vehicle. The user also checks the fuel level and makes sure there is enough fuel in the tank. After the user has completed all the above pre-fuel injection test inspection items, the user is ready to begin using application guide and vehicle look-up tables 256.

The user also performs a preliminary inspection of the vehicle. The user inspects all fuel hoses, connections and pipes from the fuel tank to the engine for signs of leakage or deterioration, and repairs or replaces them as needed. The user inspects the quality and quantity of fuel in the fuel tank and inspects the condition of the fuel filter, battery cranking system, ignition system, related electrical wiring and connections, and engine grounds.

Before connecting fuel pressure gauge 100, residual fuel pressure in the system being tested is released. On most vehicles (automobiles, trucks, construction equipment, ships, airplanes) this can be accomplished by removing the fuel cap, disabling the fuel pump, and cranking the engine for at least 30 seconds. On certain CPI and SCPI vehicles there will still be pressure in the system, so be careful when making connections to these systems. The user holds a shop towel around the fittings when making the gauge connection or disconnecting lines, to absorb any spilled fuel.

The user next installs the digital remote fuel pressure gauge 100 (FIGS. 22-25). All systems need to have gauge 100 installed without interrupting the normal fuel flow to the injector(s) where injector(s) are present. Some vehicles have fittings for connecting gauge 100, others don't have these fittings. On the vehicles that don't have fittings, gauge 100 must be tied into the pressure line of the system.

On some vehicles, the manifold and valve assembly will be used with only one leg of the manifold attached to the vehicle (FIGS. 22-25). In these cases, the user should be certain that the valve is positioned so the unattached hose is blocked.

The user next installs the manifold (FIG. 22). When testing a fuel system, the user ties into the fuel flow. On some vehicles this can be done very easily by using a JIC hose or tire valve hose assembly and tapping into fuel rail 406. The user simply uses JIC hose or hose assembly and connects gauge 100 to fuel rail 406 directly. The cover attaches the leg of the manifold that does not have ball valve 406 on it to the JIC fitting on the end of the hose. The user closes the relief valve and then attaches the clear plastic relief hose to the ball valve hose. The user momentarily opens and closes ball valve 406. The user repeats this process until fuel appears in clear plastic relief hose. (This process bleeds air from the manifold.) This allows liquid fuel to reach the probe end of the probe 226. The probe 226 is now ready to measure fuel pressure. The user now bleeds off fuel into a clear container (not shown) and examines the condition of the fuel.

The user also conducts initial tests. When beginning a fuel pressure test on a vehicle which is a “no start” vehicle, the user must be certain there is sufficient fuel in the tank. One way this can be accomplished is by attaching the appropriate adapter to the vehicle and using the 1 liter volume sample bottle and the flex hose. If the vehicle can fill bottle half way in about 15 seconds, there should be sufficient fuel available to proceed with the diagnostic tests. This is also an excellent way to visually inspect the fuel for contamination.

The user next manually activates the fuel pump of the vehicle. On most fuel injected vehicles the fuel pump will be activated for a few seconds by turning the ignition key to the “ON” position.

The user next attaches adapters to the manifold assembly. If there is no Schrader valve 408 and the user needs one of the supplied adapters, the user references look-up tables 256 to determine the adapter needled for the application. Once the adapter is identified, the user relieves the fuel pressure. Once the fuel pressure is relieved, the user disconnects the fuel line adapter and attaches male and female adapter in place (see FIG. 23). Adapters and the kits which include them, can be identified by referencing the adapter kit column of the application guide look-up tables 256.

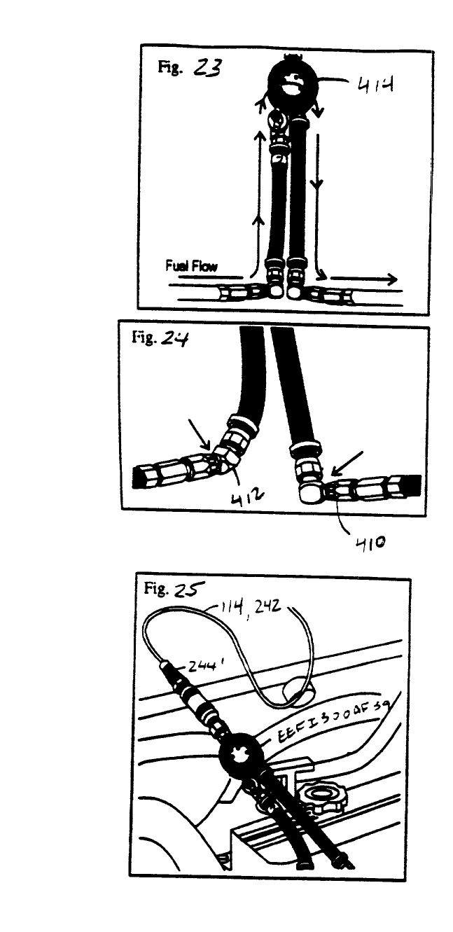

Doing this allows the use of the manifold hose assemblies to tie into the fuel flow. The manifold assembly comes with two extra hoses for length, as well as two 90° adapters 410 and two 45° adapters 412. With these combinations the user constructs the ideal manifold connection that will allow easy access to the fuel flow. (see FIG. 24). The manifold also incorporates sight glass 414 for easy identification of fuel flow and contaminants.

The user next positions the manifold. If the user plans to use the digital remote fuel pressure gauge 100 and test fuel pressure remotely while test driving, the user uses reusable ties (not shown) to attach the manifold to the fuel rail, being sure not to kink the manifold hoses. This practice will also position the manifold so the JIC probe end points to the rear of the hood to make it easy to bring wire cable 114, 242 out of the passenger window. When attaching the manifold to the adapters, the user tightens all line connections prior to pressurizing fuel rail 406.

The user next attaches the digital remote fuel pressure gauge 100 to the manifold. Once the user has completed the above, he is ready to attach probe end 232 of probe assembly 226 to the manifold. The user attaches the probe end 232 JIC swivel to the male JIC on the top of the manifold. (see FIG. 25) The user snugs down all connections with the proper wrench size to avoid any leakage and checks to be sure nothing there is nothing in the way of the hot exhaust manifold or fan blade, pulleys, etc. At this point the user is ready to energize the fuel pump bypass or start the engine.

The adapter kits described herein come with a set of adapters designed to allow the fuel flow through the supplied manifold and to allow the attachment of gauge assembly 100. With this adapter set the user may universally use the digital remote fuel pressure gauge 100. The gauge 100 is uniquely designed to be installed on the manifold and then brought through the back of the hood of the car and through the passenger side window for remote fuel pressure monitoring.

The user next connects the digital remote fuel pressure gauge 100 for remote pressure testing. One probe end 232 of unit 100 is attached to the fuel rail adapter and manifold, you may want to bring gauge assembly 100 into the vehicle for remote pressure testing. Many fuel problems are drivability problems that may only occur under load and under driving conditions. The use of gauge 100 makes this remote testing possible.

After connecting the probe end 232 of the unit 100 to the manifold, bring gauge assembly 100 out through the back of the hood then bring gauge assembly 100 in through the window of the passenger or driver side, gently closing the window on sliding sleeve 246 on wire cable 114, 242 (The user may have to adjust the position of sleeve 246 to mate with the window closing). Once gauge assembly 100 is in place in the vehicle, check to be sure that cable 114, 242 is out of harms way. Carefully close the hood, avoiding damage to or pinching cable 114, 242. Check one more time for any leaks while the engine is running, and then drop the hood closed. The weather seal along the back of most hoods will provide a good cushion and seal for the routing of wire cable 114. The user is now ready to test drive and remotely test the fuel pressure.

The user monitors the display 112 to read fuel pressure. This way of viewing the information (“in real time”) will enable the user to witness what the fuel pressure is doing visually as the user watches the display and as the vehicle is in actual operation. This means the user may notice a range of fuel pressure readouts on the display. This is a “real time” look at the condition of the Fuel system. There are many factors occurring in the fuel system that the user needs to consider. The condition of the fuel pump, pressure regulator, injectors, fuel accumulator to name a few will have a direct impact on the readout. For instance by monitoring the readings in the HI Res Mode, the user is able to find leaky injectors following rest pressure test procedures.

Gauge screen 112 has a 4 digit display which has a resolution of 1/10 psi. This feature allows the user to see very slight changes within the fuel pressure system. In the HI Res Mode, the user can actually see the fuel pressure ranging from the effects of the spring diaphragm on the control pressure regulator and the pulses from the fuel pump. Once the user has monitored the readings of a few cars with proper working fuel systems, the user will then be able to notice a problem fuel system right away. If fuel pressure ranging makes it difficult to read the screen, the unit 100 is placed in LO Res Mode. In this mode unit 100 will take several pressure samples before updating the display. This gives the user a more stable readout. The LO Res Mode is recommended as the most useful when using the gauge during a test drive.

After testing, the user removes the digital remote fuel pressure gauge 100 from the manifold by unscrewing JIC fitting. The fuel pressure may be retained by the manifold via tire valve that is in the opening of JIC fitting. Tire valve allows removal of gauge assembly 100 without loss of fuel. Once gauge assembly 100 is removed from the manifold, the user attaches clear relief hose to JIC fitting and relieves any residual fuel pressure that may be present. The user holds a shop towel around fittings to absorb any spilled fuel during all disconnects. The user removes the adapter (if used) and replaces any O-rings, sealing washers or gaskets on the disturbed fittings if needed. As such, the invention described herein provides an environmentally friendly gauge that reduces or eliminates the risk of spillage of harmful fuels or other compounds.

The user next removes the manifold. When removing the manifold the user should be sure there is no residual pressure in the fuel line by using the clear relief hose. The user removes JIC fittings from the base of the hose assemblies and any adapters being used. Once the manifold and adapters are removed the user inspects the fitting connections and cleans and replaces any O-rings or washers that may be worn before reattaching the fuel line.

Cable wire 114, 242 attaching probe assembly 226 to digital remote fuel pressure gauge assembly 100 is made from a thermoplastic elastomeric compound that is rugged. Pressure transducer is located in probe housing 120 on the end of cable 114, 242. Pressure transducer is calibrated to the board (FIG. 4) in gauge assembly 100 and is a custom mate. Locating the pressure transducer in probe assembly 226 reduces the weight of probe assembly 226 making it lighter and more maneuverable.

On all cars and light trucks (massive engines, etc.) there are four main types of fuel systems. They are:TBI (Throttle Body Injection), MFI (Multi-port Fuel Injection: injectors are pulsed at the same time), or SFI (Sequential Port Fuel Injection: injectors pulsed individually),CPI (Central Port Injection; injectors are pulsed at the same time), or SCPI (Sequential Central Port Injection; injectors pulsed individually), and a CIS (Constant Injection System; injectors flow constantly).

On GM CPI or SCPI systems, the deadhead pressure should not be exceeded. The user should slowly block the return line and release when specification is attained. If pressure is allowed to exceed 100 psi, damage to the gauge 100 may be sustained.

The returnless systems used by Chrysler uses the following components: combination fuel pressure regulator/fuel filter and fuel pump inlet filter. The metallic components are made of stainless steel for flexible fuel compatibility. The regulator/filter is located at the top of the fuel pump module. The regulator consists of a diaphragm and spring loaded check valve to control the system pressure. The pressure regulator filter is a single pass design; only the fuel needed by the engine is filtered which results in longer filter life and allows a smaller, less expensive filter to do the job. The fuel pressure is maintained constant.

The user uses various troubleshooting methods with gauge 100. There are common fuel system problems associated with all systems. First, fuel pressure may be low. The user checks and replaces the fuel filter if needed. The user checks electrical supply and ground to fuel pump, and repairs if needed. The user blocks the return line and if fuel pressure rises, the problem is most likely in the fuel pressure regulator.

If fuel pressure is still low, the user checks for: leaking injectors, a leaking fuel pressure regulator diaphragm, faulty fuel pump, a restricted fuel pump sock, leaking fuel pump pressure hose connection in fuel tank, or no fuel in the fuel tank or restricted fuel pressure line.

If fuel pressure is high, the user removes the return line at throttle body or rail and attaches a hose to the engine return fitting. The user inserts the other end of the hose into an approved container and retests the pressure. If it is now normal, the user checks and repairs restriction in the fuel return line. If the pressure is still high, the user replaces or repairs the fuel pressure regulator as needed.

The user conducts fuel pressure leak down tests with gauge 100. TBI systems may, or may not, hold pressure after the fuel pump turns off. GM TBI models, 1981-83 Chrysler Imperial 318 EFI, Izuzu TBI, Renault Alliance and Encore TBI don't hold pressure. Most others will hold pressure after the pump shuts off (key on, engine off). If this type of system bleeds down after the pump shuts off, the user blocks off the return line and cycles the key again. If pressure now holds, the problem is the fuel pressure regulator. If the pressure still drops, the user blocks off the feed line the instant the fuel pressure reaches maximum. If it now holds, pressure after the pump shuts off, the problem is in the fuel pump or the coupling in the tank. If the pressure still drops, the problem is either a leaking injector or a fuel pressure regulator diaphragm leaking into the vacuum hose.

The user also diagnoses common fuel system problems in CIS systems with gauge 100. In Bosch K-JETRONIC Systems, when checking fuel pressure, abnormal pressure readings should be handled in the following manner:

If system pressure is low the user verifies voltage and ground available at fuel pump, verifies fuel filter condition, and verifies no fuel leakage. The user carefully restricts fuel return line while monitoring system pressure. If system pressure can be brought within specifications while restricting return line, the problem is in the fuel pressure regulator (either internal fuel distributor slide valve type regulator or external diaphragm type regulator).

If the system pressure is high, the user verifies there is no restriction in return side fuel circuit (ie. the user removes return side line and runs into a suitable container). If system pressure returns to specifications, restriction is in return circuit. If system pressure does not return to specifications, problem is with the fuel pressure regulator (either internal fuel distributor slide valve type regulator or external diaphragm type regulator).

The user can also test falling rest pressure with gauge 100. All K-JETRONIC fuel pumps are equipped with a non-return valve. In some cases this check valve is replaceable, separate from the pump. If rest pressure falls, the user energizes the fuel pump long enough to pressurize the system. The user restricts the fuel return line and monitor system pressure. If system pressure still falls, the problem is with the non-return valve on the fuel pump or with the fuel accumulator. If the pressure does not fall, the problem is with the pressure regulator (either internal fuel distributor slide valve type regulator or external diaphragm type regulator).

To test the non-return valve on the fuel pump, the user energizes the fuel pump long enough to pressurize the system. The user restricts the fuel line between pump and fuel tank and monitors system pressure. If pressure no longer falls, the problem is a faulty accumulator.

Gauge 100 is also used in Bosch K & K-E series injection system test procedures. Due to the high pressures involved, proper test procedures are essential when servicing Bosch K & K-E Series injection systems. These are the adapter fittings that are needed with these systems: F17-F25, F31 & F32. The user follows these steps: When checking fuel pressure on a K or K Lambda system, gauge 100 should be hooked up in the following manner:

a. Remove the fuel line from the center top port of the fuel distributor (this is the line that goes to the control pressure regulator).

b. Place gauge 100 and shut off valve assembly so that the shut-off valve is on the control pressure regulator side.

c. Connect the shut-off valve side of gauge 100 to the control pressure regulator fuel line, then connect gauge 100 side to the center top port of the fuel distributor. Start the engine or manually energize the fuel pump (consult service manual for fuel pump relay location and bypass procedure).

d. With gauge 100 in this position and the shut-off valve closed, system pressure is measured.

When checking fuel pressure on a K-E system, gauge 100 should be hooked up in the following manner: remove the fuel line to the cold start injector, place gauge 100 and shut-off valve assembly so that the shut-off valve is on the fuel distributor side,connect the shut-off valve side of gauge 100 and shut-off valve assembly to the fuel distributor test port, connect gauge 100 side to the cold start injector fuel line. Start the engine, or manually energize the fuel pump (consult the service manual for fuel pump relay location and bypass procedure). With gauge 100 in this position and the shut-off valve open, differential pressure is measured; with the shut-off valve closed, system pressure is measured. (An alternative method of measuring differential pressure is to dead head gauge 100 to the fuel distributor test port. Only differential pressure is measured in this case.)

To check system rest pressure, gauge 100 should be hooked up in the same manner as for testing system pressure. The system should hold a specific rest pressure for a specific amount of time (consult fuel pressure chart for values). After testing, be sure to replace any banjo washers with new ones and be sure to test system for leaks before releasing the vehicle to the customer.

Digital remote fuel pressure gauge assembly 100 has many other uses that include marine and airplane uses. With the air pressure attachment, gauge 100 can be used to test air pressure of the tire as well as the temperature. The user can monitor the oil pressure and temperature as well when gauge 100 is combined with oil pressure test kit.

Application guide/vehicle look-up tables 256 are attached hereto as Appendix A. Tables 256 includes application guide heading definitions as follows:

Make & Model: Vehicle Designation

Engine: is either a displacement and injection description; or an engine code that is listed on the engine decal.

From Year/To Year: the beginning and ending years for the particular information contained in this line.

VIN: Vehicle Identification Number, the engine code contained in the VIN number (10 digits) at the base of the windshield. Imports do not use this code in this chart.

KOEO: stands for “key on; engine off”

Normal Idle: engine at normal operation temperature, low idle speed

Idle w/o Vacuum: applies to port injected vehicles. This is the pressure of the system with the vacuum removed from the fuel pressure regulator.

Deadhead: the system pressure with the return line blocked off.

Adapter Fitting: the adapter fitting(s) needed to attach pressure gauge to vehicle.

Adapter Kit: indicates in which kit the listed adapter is available.

Fitting Location: where the adapter is installed on the vehicle.

Manual Pump Energize: how to activate the fuel pump without the engine running.

RPO: Regular Production Option: the production code contained in the vehicle option label.

European Fuel Pressure CIS Tables:

System Pressure: pressure reading while vehicle is being operated (driven).

Control/Differential Warm: pressure reading achieved once engine has warmed and is idling.

Control /Differential @68F: pressure reading at room temperature once vehicle has been shut down and allowed to surpass rest pressure (while stored indoors).

Rest Pressure: pressure reading reached once vehicle has been turned off and reached rest time.

Rest Time: amount of time required to reach rest pressure.

GM: Grand Master Kit (#EEFI300AM)

DM: Domestic Master Kit (#EEFI300ADM)

FM: Foreign Master Kit (#EEFI300AFM)

DB: Domestic Basic Kit (#EEFI300ADM)

FB: Foreign Basic Kit (#EEFI300AFB)

N/A: Not Applicable

The following are general guidelines for using the enclosed Vehicle Look-up Tables 256. The user locates the vehicle in question in the look-up table headings by utilizing one or all of the following: Make & Model of vehicle, Engine, from Year/to Year, or VIN.

Once the vehicle has been identified, the proper adapter(s), as well as the fitting location will need to be determined. This information is found under the columns entitled Adapter Fitting and Fitting Location. Following the line for the specific vehicle over to these columns to find the information needed. The Adapter Fitting column lists the actual fitting needed. The number listed corresponds to the number stamped on the adapter in the kit. The Fitting Location column will tell the technician where in the vehicle to attach the designated adapter. The Fitting Location column uses a footnote method to provide all the required information. The technician needs to reference the numbered footnote given in this column. The number (found in parenthesis within the column) is referenced in the ‘Key to Look-up Table Footnotes’ found herein and provides an explanation as to where the fuel connection can be located for the specific vehicle.

This same method of identifying information is used with the KOEO, Normal Idle and Manual Pump Energize columns.

After choosing the adapter and referencing the Fitting Location, the additional columns of KOEO, Normal Idle, Idle w/o Vacuum and Deadhead Pressure will provide the technician with additional pertinent information. Listed in these columns are the actual pressure or pressure range which can be read from the Digital Remote Fuel Pressure Gauge for the vehicle being tested. KOEO indicates (for those vehicles listing a reading and/or a footnote) that a fuel pressure reading can be made with the key on without the engine running.

The European Fuel Pressure CIS tables list those vehicles with CIS fuel pressure systems. Use these tables the same way as described above. The difference in these tables is in the way the information is given: ie., there are 4 columns which list the fuel pressure readings in both bar & psi measurement which replace the columns VIN through Deadhead Pressure.

The parts for the grand master kit 258 are as follows:

| Product Description: | | Part #: | Quantity: |
|---|---|---|---|
| Digital Remote | | EEFI300A | 1 |
| Fuel Pressure Gauge 100 | | | |
| Lithium Batteries (CR2032) 236 | | EEFI300AF50 | 2 |
| Gauge Boot 300 | | EEFI300AF51 | 1 |
| Adapter Kit Manual & | | ZEEFI300AF47 | 1 |
| Look-up Tables 256 | | | |
| Adapters: | F1AS | EEFI300AF1 | 1 |
| | F2AS | EEFI300AF2 | 1 |
| | F3AS | EEFI300AF3 | 1 |
| | F4AS | EEFI300AF4 | 1 |
| | F5AS | EEFI300AF5 | 1 |
| | F6 | EEFI300AF6 | 1 |
| | F7AS | EEFI300AF7 | 1 |
| | F8 | EEFI300AF8 | 1 |
| | F9 | EEFI300AF9 | 1 |
| | F10AS | EEFI300AF10 | 1 |
| | F11 | EEFI300AF11 | 1 |
| | F12 | EEFI300AF12 | 1 |
| | F13AS | EEFI300AF13 | 1 |
| | F14 | EEFI300AF14 | 1 |
| | F15 | EEFI300AF15 | 1 |
| | F16AS | EEFI300AF16 | 1 |
| | F17AS | EEFI300AF17 | 1 |
| | F18AS | EEFI300AF18 | 1 |
| | F19AS | EEFI300AF19 | 1 |
| | F20AS | EEFI300AF20 | 1 |
| | F21AS | EEFI300AF21 | 1 |
| | F22AS | EEFI300AF22 | 2 |
| | F23 | EEFI300AF23 | 1 |
| | F24AS | EEFI300AF24 | 1 |
| | F25 | EEFI300AF25 | 1 |
| | F26AS/2 screws | EEFI300AF26 | 1 |
| | (M6 × 1.0 × 50 mm) | | |
| | F27 | EEFI300AF27 | 1 |
| | F28 | EEFI300AF28 | 1 |
| | F29 | EEFI300AF29 | 1 |
| | F30AS | EEFI300AF30 | 1 |
| | F31 | EEFI300AF31 | 1 |
| | F32 | EEFI300AF32 | 1 |
| | 45° Elbow | EEFI300AF33 | 2 |
| | 90° Elbow | EEFI300AF34 | 2 |

| | | |
|---|---|---|
| Hose clamps | EEFI300AF35 | 2 |
| ⅜″ ID Hose/3″ length | EEFI300AF36 | 2 |
| ¼″ ID Hose/3″ length | EEFI300AF37 | 2 |
| ¼″ ID Fuel Flex tubing | EEFI300AF38 | 1 |
| w/male 7/16 JIC/4″ length | | |
| Manifold Assembly | EEFI300AF38 | 1 |
| Manifold Extension Hose | EEFI300AF39 | 1 |
| Assemblies | | |
| Grand Master Accessory Bag | EEFI300AF41 | 1 |
| 5″ Zip Strips | EEFI300AF46 | 2 |
| 8″ Zip Strips | EEFI300AF47 | 1 |
| Blow-molded Case | EEFI300AF48 | 1 |

The parts for the domestic master kit 260 are as follows:

| Product Description: | | Part #: | Quantity: |
|---|---|---|---|
| Adapter Kit Manual & Look-up | | ZEEFI300AF47 | 1 |
| Tables 256 | | | |
| Adapters: | F1AS | EEFI300AF1 | 1 |
| | F2AS | EEFI300AF2 | 1 |
| | F3AS | EEFI300AF3 | 1 |
| | F4AS | EEFI300AF4 | 1 |
| | F5AS | EEFI300AF5 | 1 |
| | F6 | EEFI300AF6 | 1 |
| | F7AS | EEFI300AF7 | 1 |
| | F8 | EEFI300AF8 | 1 |
| | F9 | EEFI300AF9 | 1 |
| | F10AS | EEFI300AF10 | 1 |
| | F11 | EEFI300AF11 | 1 |
| | F12 | EEFI300AF12 | 1 |
| | F13AS | EEFI300AF13 | 1 |
| | F14 | EEFI300AF14 | 1 |
| | F15 | EEFI300AF15 | 1 |
| | F16AS | EEFI300AF16 | 1 |
| | F19AS | EEFI300AF19 | 1 |
| | F26AS | EEFI300AF26 | 1 |
| | F27 | EEFI300AF27 | 1 |
| | F28 | EEFI300AF28 | 1 |
| | F29 | EEFI300AF29 | 1 |

The parts for the foreign basic kit 272 are as follows:

| Product Description: | | Part #: | Quantity: |
|---|---|---|---|
| Adapter Kit Manual & Look-up Tables | | ZEEFI300AF47 | 1 |
| Adapters: | F2AS | EEFI300AF2 | 1 |
| | F3AS | EEFI300AF3 | 1 |
| | F16AS | EEFI300AF16 | 1 |
| | F18AS | EEFI300AF18 | 1 |
| | F20AS | EEFI300AF20 | 1 |
| | F21AS | EEFI300AF21 | 1 |
| | F22AS | EEFI300AF22 | 2 |
| | F23 | EEFI300AF23 | 1 |
| | F24AS | EEFI300AF24 | 1 |
| | F25 | EEFI300AF25 | 1 |
| | F27 | EEFI300AF27 | 1 |
| | 45 degree elbow | EEFI300AF33 | 2 |
| | 90 degree elbow | EEFI300AF34 | 2 |

| | | |
|---|---|---|
| Hose Clamps | EEFI300AF35 | 2 |
| ¼″ ID Hose/3″ length | EEFI300AF37 | 2 |
| ¼″ ID Fuel Flex tubing w/male | EEFI300AF38 | 1 |
| 7/16 JIC/4″ length | | |
| Manifold Assembly | EEFI300AF39 | 1 |
| Manifold Extension Hose Assemblies | EEFI300AF40 | 1 |
| Foreign Basic Accessory Bag | EEFI300AF45 | 1 |
| 5″ Zip Strips | EEFI300AF46 | 2 |
| 8″ Zip Strips | EEFI300AF47 | 1 |
| Blow-molded Case | EEFI300AF49 | 1 |

Optional accessories for the kits described herein include knee board attachment (not shown) to allow the user to hold and read gauge 100 with hands free to make notes on attached pad, 1 liter sample bottle used for volume testing fuel and air chuck attachment.

The parts for the domestic master kit 260 include:

| Product Description: | Part #: | Quantity: |
|---|---|---|
| F30AS | EEFI300AF30 | 1 |
| 45° Elbow | EEFI300AF33 | 2 |
| 90° Elbow | EEFI300AF34 | 2 |
| Hose clamps | EEFI300AF35 | 2 |
| ⅜″ ID Hose/3″ length | EEFI300AF36 | 2 |
| ¼″ ID Hose/3″ length | EEFI300AF37 | 2 |
| ¼″ ID Fuel Flex tubing w/male | EEFI300AF38 | 1 |
| 7/16 JIC/4″ length | | |
| Manifold Assembly | EEFI300AF39 | 1 |
| Manifold Extension Hose Assemblies | EEFI300AF40 | 1 |
| Domestic Master Accessory Bag | EEFI300AF42 | 1 |
| 5″ Zip Strips | EEFI300AF46 | 2 |
| 8″ Zip Strips | EEFI300AF47 | 1 |
| Blow-molded Case | EEFI300AF48 | 1 |

The parts for the foreign master kit 268 include:

| Product Description: | | Part #: | Quantity: |
|---|---|---|---|
| Adapter Kit Manual & Look-up Tables | | ZEEFI300AF47 | 1 |
| Adapters: | F1AS | EEFI300AF1 | 1 |
| | F2AS | EEFI200AF2 | 1 |
| | F3AS | EEFI300AF3 | 1 |
| | F14 | EEFI300AF14 | 1 |
| | F15 | EEFI300AF15 | 1 |
| | F16AS | EEFI300AF16 | 1 |
| | F19AS | EEFI300AF19 | 1 |
| | F26AS | EEFI300AF26 | 1 |
| | F27 | EEFI300AF27 | 1 |
| | F31 | EEFI300AF31 | 1 |
| | F32 | EEFI300AF32 | 1 |
| | 45° Elbow | EEFI300AF33 | 2 |
| | 90° Elbow | EEFI300AF34 | 2 |

| | | |
|---|---|---|
| Hose clamps | EEFI300AF35 | 2 |
| ¼″ ID Hose/3″ length | EEFI300AF37 | 2 |
| ¼″ ID Fuel Flex Tubing w/male | EEFI300AF38 | 1 |
| 7/16 JIC/4″ length | | |
| Manifold Assembly | EEFI300AF39 | 1 |
| Manifold Extension Hose Assemblies | EEFI300AF40 | 1 |
| Foreign Master Accessory Bag | EEFI300AF44 | 1 |
| 5″ Zip Strips | EEFI300AF46 | 2 |
| 8″ Zip Strips | EEFI300AF47 | 1 |
| Blow-molded Case | EEFI300AF48 | 1 |

The parts for the domestic basic kit 270 include:

| Product Description: | | Part #: | Quantity: |
|---|---|---|---|
| Adapter Kit Manual & Look-up Tables | | ZEEFI300AF47 | 1 |
| Adapters: | F1AS | EEFI300AF1 | 1 |
| | F2AS | EEFI300AF2 | 1 |
| | F3AS | EEFI300AF3 | 1 |
| | F4AS | EEFI300AF4 | 1 |
| | F5AS | EEFI300AF5 | 1 |
| | F19AS | EEFI300AF19 | 1 |
| | F27 | EEFI300AF27 | 1 |
| | F28 | EEFI300AF28 | 1 |
| | 45 Elbow | EEFI300AF33 | 2 |
| | 90 Elbow | EEFI300AF34 | 2 |

| | | |
|---|---|---|
| Hose clamps | EEFI300AF35 | 2 |
| ⅜″ ID Hose/3″ length | EEFI300AF36 | 2 |
| ¼″ ID Hose/3″ length | EEFI300AF37 | 2 |
| ¼″ ID Fuel Flex tubing w/male | EEFI300AF38 | 1 |
| 7/16 JIC/4′ length | | |
| Manifold Assembly | EEFI300AF39 | 1 |
| Manifold Extension Hose Assemblies | EEFI300AF40 | 1 |
| Domestic Basic Accessory Bag | EEFI300AF43 | 1 |
| 5″ Zip Strips | EEFI300AF46 | 2 |
| 8″ Zip Strips | EEFI300AF47 | 1 |
| Blow-molded Case | EEFI30 | |

Appendix B includes a copy of a computer program for actuating and running gauge 100. Parts, components and adapters described herein are commercially available and can be purchased from Waekon Industries, Inc., P.O. Box 90, Kirkwood. Pa. 17536. Appendix C includes a parts list for the circuitry of FIG. The parts listed in Appendix C are commercially available from various vendors including by way of example, NIC, NEMCO, PANASONIC, THOMPSON, PHILIPS, DALE, ABRACON, NATIONAL SEMICONDUCTOR, SGS THOMPSON, NJRC, TI, TELCOM, SEIKO, ITT, SIPEX, MICROCHIP, DB PRODUCTS, CLOVER, TCT COILS, JW MILLER, Q-TECH, AMERICAN ZETTLER, KOA, ROHM, CAL-CHIP, KEMET, NEMCO, AVX AND MKS. Items 54-67 are commercially available from Waekon Industries, Inc., Kirkland, Pa. The chip of item 59 is programmed by PIONEER TECHNINCAL GROUP, Horsham, Pa. who is a distributor for MICRO-CHIP who is the manufacturer of the chip. Appendix B contains the routines resident on the chip of item 59. Item 63 of Appendix C is a circuit board. Item 66 is an LCD that is supplied by AMERICAN ZETTLER of Pennsylvania which contains the combination of lettering appearing on the LCD as shown in the FIGS. herein.

Item 61 are battery clips which are illustrated in FIGS. 30-30b. FIGS. 30-30b include a top, side and frontal view of battery hold down clip 61 used in gauge 100, 100′. Hold down clip 61 is generally made from spring steel that is nickel plated and a thinckness of 0.015 inches. The temper of the clip 61 is such that it exerts pressure on a variety of batteries 1/16 to 3/16 of an in thick without deforming the clip 61.

Exemplary heat passive alloys include various metals, aluminum, steel, cooper and brass.

Gauge 100 can also have a variety of additions. These additions include voice chips and circuitry. Voice chips and circutiry similar to those found in telephones can be added to the visual display addition or substituted therefor. Hence, a user can be audibly prompted by gauge 100 with respect to function entries or measurements. Pressure measurements can be either positive or negative pressure measurements.

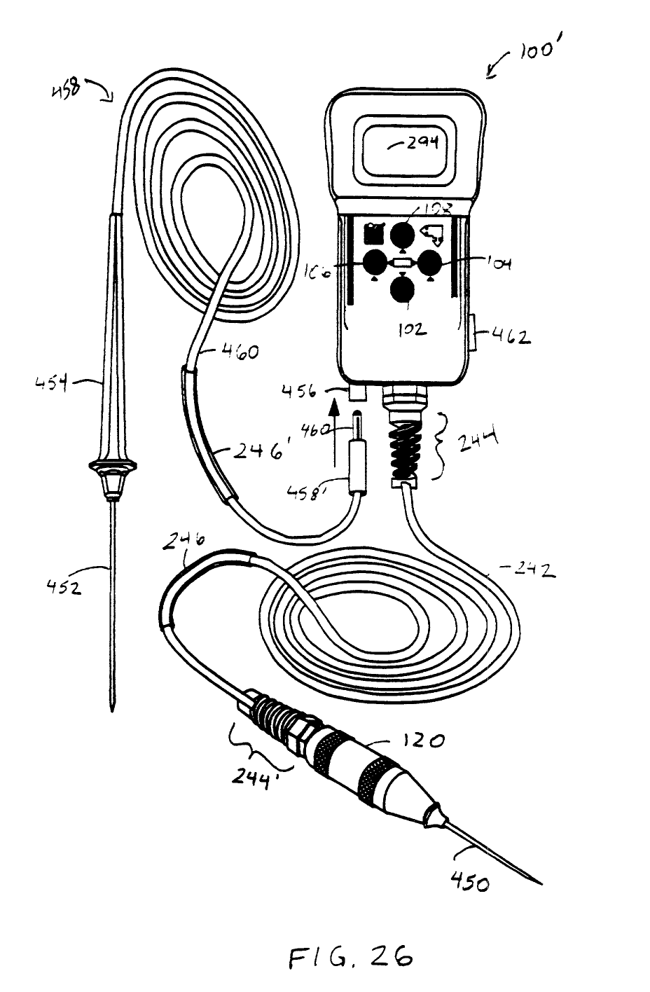

FIG. 26 illustrates a variant of gauge 100, gauge 100′. Gauge 100′ includes an addition to the circuitry of gauge 100 that includes a switchable, detachable, second probe temperature sensing probe 458 for the measurement of temperature. Probe addition 458 includes electrical connector 460 which mates with electrical connector communication port 456 of gauge 100′. Electrical connector 460 is housed in insulating jacket 458, and communicates with needle probe 452 by way of cable 460. Needle 460 is fixedly secured in handle member 454. Cable 460 has optional sleeve member 246′ which is similar to sleeve 246. Probe body 120 has a needle pressure probe attachment 450 connected thereto. Temperature probe 458 mates with gauge 100′ at communication port 456. A routine on gauge 100′ provides for a simultaneous measurement of temperature with temperature probe 458, and measurement of pressure with probe assembly 120. It is appreciated that the temperature compensation circuitry and routines (software, hardware or firmware, etc.) allow gauge 100 to auxiliary connections such as removable, detachable temperature probe connections which are simultaneously attached with pressure probe assembly 120. These attachments simultaneously and independently read measurements from the probe temperature assembly 120 (with the switching being done mechanically within the connector (which may include internal switching), or electronically. The programming within gauge 100′ accommodates various applications. It is appreciated that having dual probes on gauge 100′ permits simultaneously reading the following combinations of measurements: two independent temperature measurements, one pressure measurement and one temperature measurement, or two pressure measurements. These measurements can be taken at two different locations on a single source or at two different independent sources as needed. In this variant, two readings are displayed of display 112 in one variant of the invention. In another variant of the invention the measurements on display 112 alternate between the measurement taken by probe 458 and probe assembly 120 for a time out period.

Various pressure ranges are accommodates with different additions of pressure sensors, and related routine modifications for different conversion and display values. These values include: 1-100 PSI for air pressure, and fuel injection pressure, 1-300PSI for transmission pressure, and 1-4000 PSI for air conditioning pressure, power steering (rack) pressure, and hydraulic system pressure. Gauge 100, 100′ can measure either positive or negative pressure readings in one embodiment.

The pressure and temperature data is easily downloaded to a desk top computer 492 or a portable computer using a serial link via an optical interface addition in gauge 100, 100′ (infra-red or visible light or other electromagnetic spectrum radiation)(not shown) to a suitable receiver or docking station (not shown) attached to RS 232 compatible interface or other appropriate electrical interface. This feature permits quick and accurate data collection and analysis from gauge 100, 100′. Gauge 100′ has all supporting components necessary for such a feature including optional PC RS232 adapter 462. The system also includes supporting communications routines for communicating data from gauge 100, 100′ to computer 492. Computer 492 also includes routines for analyzing that data collected at unit 100.

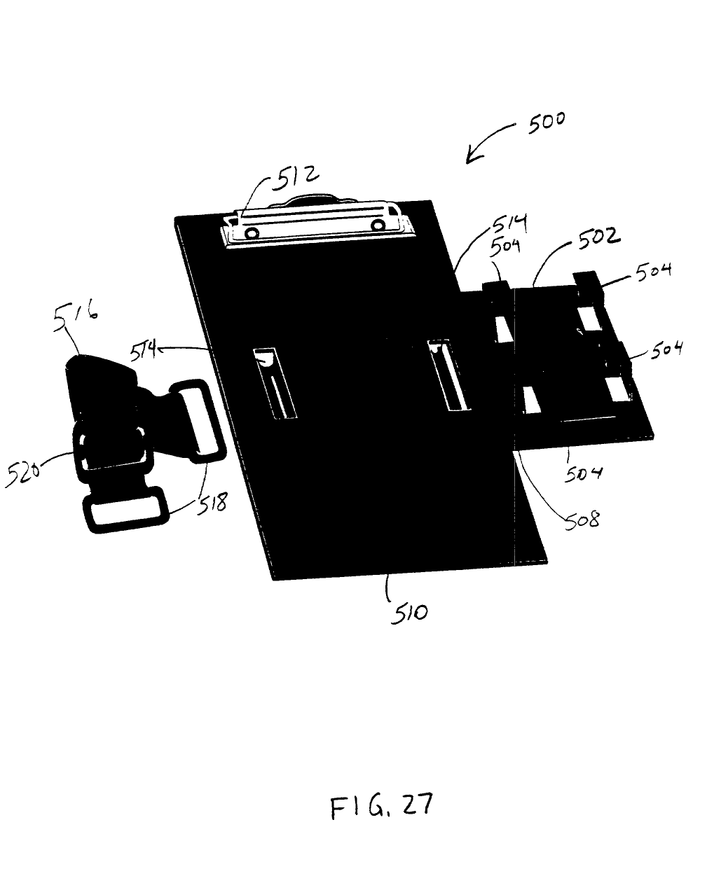

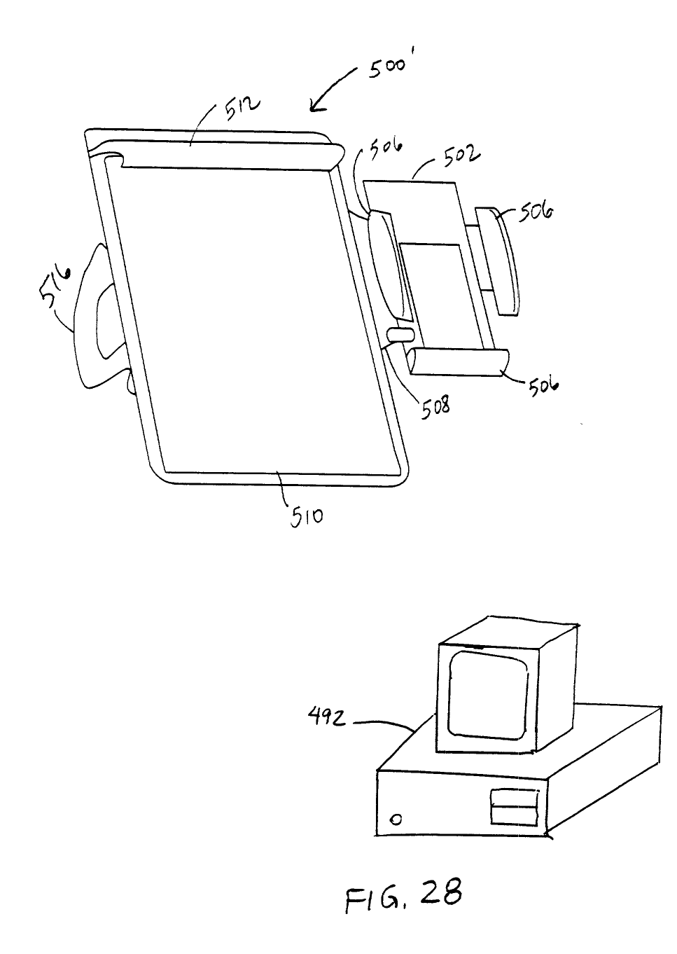

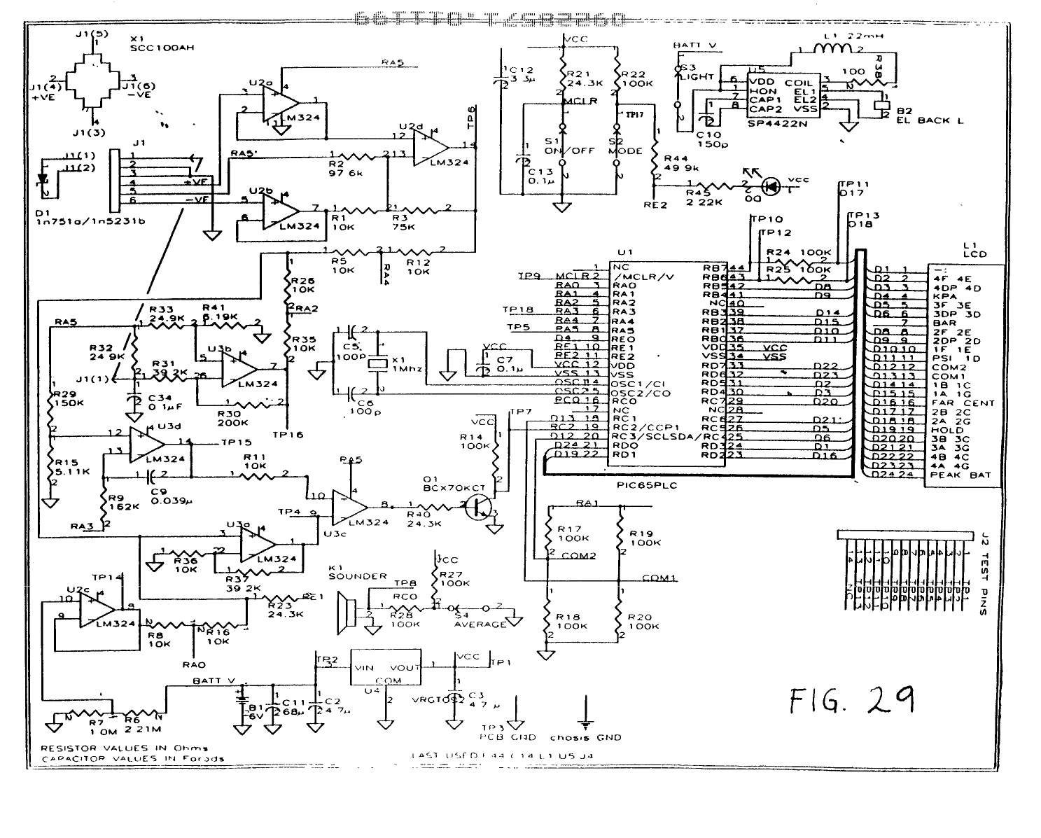

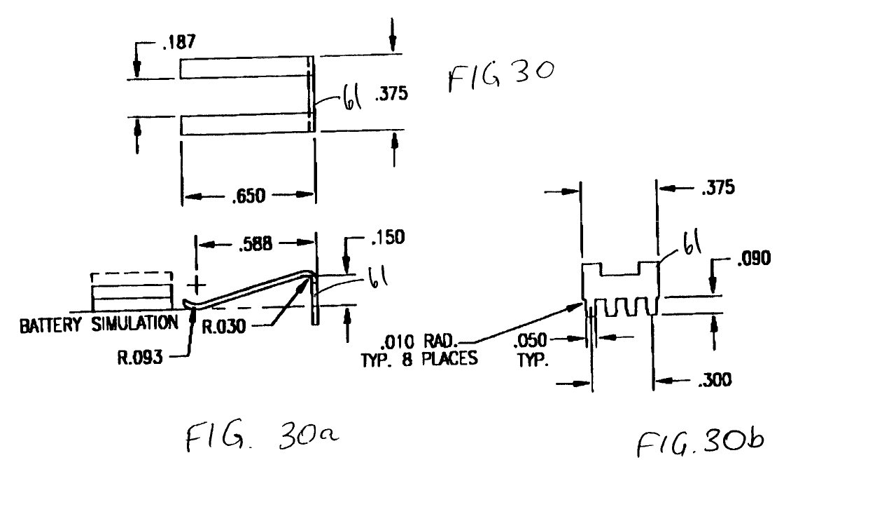

FIGS. 27-28 illustrate variants of kneeboard 500, 500′. Kneeboards 500, 500′ include a docking station 502 for gauge 100. Docking station 502 includes a plurality of prongs 504 for removable or fixedly securing gauge 100, 100′ to the docking station. Optionally a pair of side walls 506, and bottom member 506 are provided as shown in FIG. 28. It is appreciated that docking station 502 is made to removable secure gauge 100 and can have a variety of configurations. Docking station is connected either integrally or removable to note pad base member 510 by connecting member 508. Base member 510 can have optional note pad securing means 512 which may be a clip or other appropriate means. Base member 510 also optionally has hook projections 514 extending below base member 510 and spaced one from another about the width of an average adult males/females leg. Removable securing strap 516 has loop members 518 which connect to hook projections 514 to secure the kneeboard to an appropriate appendage of a user, e.g. the user's leg or arm. Strap 516 is adjustable with adjustment 520.

FIG. 29 is a variant of the circuitry of FIG. 4. The part list attached as Appendix C describes that various parts in FIG. 29. The parts in Appendix C are commercially available as described above.

Gauge 100 also includes probe addition communication port 462 which is a RS 232 compatible interface or other appropriate electrical interface.

While only a few, preferred embodiments of the invention have been described hereinabove, those of ordinary skill in the art will recognize that the embodiment may be modified and altered without departing from the central spirit and scope of the invention. Thus, the preferred embodiment described hereinabove is to be considered in all respects as illustrative and not restrictive, the scope of the invention being indicated by the appended claims, rather than by the foregoing description, and all changes which come within the meaning and range of equivalency of the claims are intended to be embraced herein.

I claim:

1. A digital pressure or temperature gauge, comprising:
a gauge body dimensioned to be held in the palm of a user's hand, the gauge body having microprocessor controlled circuitry therein, an altitude and temperature compensation means in communication with said microprocessor, and keys for actuating said microprocessor;
a display disposed on said gauge body for informing the user of readings taken in a mode of operation of said device;
a probe assembly remote from said gauge body; and,
a multi-conductor shielded cable connecting said gauge body and said probe assembly, said cable providing a communication link between said probe assembly and said circuitry, and said cable being dimensioned and constructed to allow a user to manipulate said keys on said gauge body while said probe assembly is in an actual test position on a component of a vehicle, while said vehicle is in motion and while said user is operating said vehicle, and said digital pressure gauge being self-powered and having roaming and remote use capability.

2. The gauge of claim 1 further comprising routines providing a plurality of said modes of operation of said gauge, said modes of operation including, in combination, a PSI mode which said display presents a pressure read in pounds per square inch measurement, a KPA mode in which said display presents a pressure read in kilo pascal measurement, a PEAK HOLD mode in which said display presents a highest pressure read during a sample of measurements taken by said gauge, a HI/LO resolution mode in which said display displays one of a LO resolution mode which presents an average pressure taken from a batch of at least 8 consecutive readings or a HI resolution mode which presents the pressure in a system being measured in real time, and a temperature mode in which said display presents a temperature of a fluid being tested in either °C. (Centigrade) or °F. (Fahrenheit).

3. The gauge of claim 1 in which said gauge body includes an anodized aluminum casing which protects said microprocessor and microprocessor controlled circuitry,
whereby said gauge is ruggedly built and capable of withstanding use in a shop environment.

4. The gauge of claim 1 in which said probe assembly houses said pressure transducer and a temperature compensation component, said probe assembly includes a JIC connector, and said probe assembly is constructed of a heat passive alloy.

5. The gauge of claim 1 in which said gauge body further houses no more than four pressure sensitive polymer function buttons actuating said modes of operation of said device,
whereby said user can easily manipulate a change in the modes of operation of said gauge while said vehicle is in motion.

6. The gauge of claim 1 further comprising at least one pliable, water-resistant seal protecting a connection between said cable, said gauge body, and said probe assembly.

7. The gauge of claim 1 further comprising a durable and pliable protective sleeve slidably positioned on said cable for protection of said cable when said gauge is used remotely.

8. The gauge of claim 1 in which said sleeve is made of a substantially rigid material and is sized and dimensioned to slide along said cable.
whereby positioning of said sleeve and said cable in a passenger or driver's side window is greatly facilitated while test driving this vehicle.

9. The gauge of claim 1 further comprising a removable protective boot to provide added protection to said gauge body, said boot being molded to fit said gauge body snugly and designed for a comfortable and effective hand grip.

10. A kit for remotely measuring pressure or temperature, comprising the gauge of claim 2, and at least five gauge accessories, said accessories selected from the group consisting of batteries, a gauge boot, an adapter kit manual & look-up tables; adapters selected from the group consisting of an F1AS adapter, an F2AS adapter, an F3AS adapter, an F4AS adapter, an F5AS adapter, an F6 adapter, an F7AS adapter, an F8 adapter, an F9 adapter, an F10AS adapter, an F11 adapter, an F12 adapter, an F13AS adapter, an F14 adapter, an F15 adapter, an F16AS adapter, an F17AS adapter, an F18AS adapter, an F19AS adapter, an F20AS adapter, an F21AS adapter, an F22AS adapter, an F23 adapter, an F24AS adapter, an F25 adapter, an F26AS/2 adapter, screws (M6×1.0×50 mm), an F27 adapter, an F28 adapter, an F29 adapter, an F30AS adapter, an F31 adapter, an F32 adapter, a 45° elbow, a 90° elbow, hose clamps, a ⅜″ ID Hose/3″ length, a ¼″ ID Hose/3″ length, ¼″ ID fuel flex tubing, a w/male 7/16 JIC/4″ length, a manifold assembly, a manifold extension hose, an accessory gag, 5″ Zip strips, 8″ Zip strips, a knee-board attachment, an air chuck, a bottle, and a blow-molded case.

11. A method of measuring a pressure or temperature on a component of a vehicle while said vehicle is moving and in operation, comprising the steps of:
providing a digital pressure or temperature gauge, said gauge having a gauge body dimensioned to be held in the palm of a user's hand, said gauge body having microprocessor controlled circuitry therein, an altitude and temperature compensated pressure transducer in communication with said microprocessor, and keys for actuating said microprocessor; a display disposed on said gauge body for informing the user of readings taken in a mode of operation of said device; a probe assembly; and, a multi-conductor shielded cable connecting said gauge body and said probe assembly, said cable providing a communication link between said probe assembly and said circuitry, and said cable of a length sufficient to allow a user to manipulate said keys on said gauge body while said probe assembly is in an actual test position on a component of a vehicle and while said vehicle is actually in motion and while said user is operating said vehicle;
connecting said probe assembly to said component of said vehicle while said vehicle is stationary, said component being remote from a passenger compartment of said vehicle;
positioning said gauge body in a convenient, easily viewable position with respect to said user in said passenger compartment of said vehicle;
actuating movement of said vechicle; and,
viewing readings on said display in response to actuating said keys on said gauge while said vehicle is moving.

12. The method of claim 11 in which said component is selected from the group consisting of a fuel system, an engine, and a fuel injector system; and, said vehicle is selected from the group of vehicles that move on land, vehicles that move in air, vehicles that move on water, vehicles that move under water, and vehicles that move under ground.

13. The method of claim 11 further comprising the steps of actuating a mode of operation of said gauge, said mode of operation including, a PSI mode which said display presents a pressure read in pounds per square inch measurement, a KPA mode is in which said display presents a pressure read in kilo pascal measurement, a PEAK HOLD mode in which said display presents a highest pressure read during a sample of measurements taken by said gauge, a HI/LO resolution mode in which said display displays one of a LO resolution mode which presents an average pressure taken from a batch of at least 8 consecutive readings or a HI resolution mode which presents the pressure in a system being measured in real time, and a temperature mode in which said display presents a temperature of a fluid being tested in either °C. (Centigrade) or °F. (Fahrenheit).

14. The method of claim 11 further comprising the step of sensing a pressure or temperature at said probe assembly with a pressure transducer or a temperature compensation component, and communicating a signal correlated to said pressure or temperature from said probe assembly through said cable.

15. The method of claim 11 further comprising the step of sliding a durable and pliable protective sleeve along said cable to a predetermined position that may result in damage to said cable for protection of said cable when said gauge is used remotely.

16. The method of claim 12 in which said vehicle is a vehicle that travels on land, and further comprising the step of positioning said sleeve where a passenger side window of said vehicle closes on said cable when said gauge is being used to read pressure while test driving this vehicle.

17. The method of claim 11 further comprising the step of placing a removable protective boot on said gauge body.

18. The method of claim 11 in which said gauge body includes a magnetically attracting material and further comprising the step of positioning said gauge body on a magnetically attracted material to assist said user in viewing said display.

19. The method of claim 11 further comprising the step of periodically calibrating said gauge when said vehicle is stationary.

20. The method of claim 11 further comprising the step of automatically compensating for temperature with said microprocessor.

21. The gauge of claim 1 further comprising automatic temperature compensation means in communication with said circuitry.

22. The gauge of claim 21 in which said circuitry further comprises diodes.

23. The gauge of claim 1 in which voice circuitry audibly describing said measurement is substituted for said display.

24. The gauge of claim 1 in which said pressure is selected from the group consisting gas pressure and liquid pressure.

25. The gauge of claim 1 in which said pressure is selected from the group consisting of fuel pressure, transmission pressure, steering pressure, brake fluid pressure, vacuum pressure, water pressure, oil pressure, air conditioning pressure, gas tank gas pressure, fuel pressure, cooling pressure, and air pressure.

26. The gauge of claim 1 further comprising a probe addition communication port, a temperature probe mating with said communication port, and a routine on said device providing for a simultaneous measurement of temperature with said temperature probe, and measurement of pressure with said probe assembly.

27. The gauge of claim 26 in which said probe addition communication port is an RS 232 compatible interface.

28. The gauge of claim 26 in which said display alternates between a measurement taken by said temperature probe and said probe assembly, said measurements being displayed for a predetermined period of time.
